(19) United States
(12) Patent Application Publication
(10) Pub. No.: US 2024/0354672 A1
(43) Pub. Date: Oct. 24, 2024

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Yoshiaki SHOJI, Musashino-shi, Tokyo (JP); Shiro OGASAWARA, Musashino-shi, Tokyo (JP)

(73) Assignee: NIPPON TELEGRAPH AND TELEPHONE CORPORATION, Tokyo (JP)

(21) Appl. No.: 18/685,926

(22) PCT Filed: Aug. 26, 2021
(86) PCT No.: PCT/JP2021/031350

§ 371 Date: Feb. 23, 2024

(51) Int. Cl. G06Q 10/0631; G06F 16/383

(52) U.S. Cl. CPC G06Q 10/063112; G06F 16/383

(57) ABSTRACT

An information processing apparatus includes an information acquisition unit that acquires first text information handled in a terminal apparatus of a first user in response to a search request issued by the first user to search for candidate users from among a plurality of users. There is a condition generation unit that divides words included in the first text information into a first word group having an appearance frequency lower than a first threshold and a second word group having an appearance frequency equal to or higher than the first threshold according to an appearance frequency in second text information related to past work of the first user. Further, there is a search processing unit that extracts the candidate users from among users according to an appearance frequency of a word belonging to the first word group in third text information related to past work of each user.

### TECHNICAL FIELD

Embodiments of the present invention relate to an information processing apparatus, an information processing method, and a program.

### BACKGROUND ART

In a company or the like, a role (charge of personnel affairs, charge of accounting, or the like) is assigned to a worker, and work is performed according to the assigned role. Each worker of each role is a human resource whose skill set including experience is uniform to some extent. It is conceivable that each worker can naturally hear a conversation between surrounding people without directly participating in the conversation, and can find out, in everyday life, who takes counsel, with whom the counselee takes counsel, what kind of counsel the counselee takes, what each worker is familiar with, who is in trouble, and what is the trouble.

In the future, with the diversification of work forms, it is conceivable that skill sets possessed by human resources will be diversified. In addition, it is assumed that a work execution system is formed in which a remote environment and an office environment are mixed, and opportunity to hear communication of the surroundings as described above decreases.

Therefore, it is expected that there will be various situations in which each worker needs help.

It may be more difficult than before for a person in need of help to grasp what each worker is familiar with, which serves as prerequisite knowledge, and to find an appropriate counselor when a trouble occurs. Further, it is expected that it will be more difficult than before for a person who gives help to determine which trouble the person can easily help to solve on the basis of its own experience.

As described above, when a trouble that requires counsel with another person occurs in work or the like, a person who wants to take counsel has a need to search for a counselor having experience related to the trouble. Here, a technique has been proposed that enables a search for a user in a company who has abundant knowledge about what one wants to know (see, for example, Non Patent Literature 1).

The method proposed in Non Patent Literature 1 derives information regarding a trouble of a counselee who is a worker having the trouble from “current work situation” and “accumulated work experience” expressed as vocabulary distributions in a terminal log, and extracts counselor candidates who are a person who is likely to have work experience of solving the trouble under the same situation by comparing vocabulary distributions. Then, in the method proposed in Non Patent Literature 1, among these counselor candidates, a person who has more work experience similar to that at the time of consultation of the counselee and is likely to smoothly understand the trouble and present a solution is selected as the counselor.

### CITATION LIST

### Non Patent Literature

Non Patent Literature 1: Gyoumu keiken no suriawase ni yoru soudansha pearingu gijutsu (in Japanese) (Counselee Pairing Technique by Comparing of Work Experiences), R6-9, Tsukuba Forum 2020 ONLINE, Oct. 29, 2020-Oct. 30, 2020.

### SUMMARY OF INVENTION

### Technical Problem

However, there may be a case where the trouble cannot be solved only by having many solving experiences under the same situation as the trouble of the counselee.

This invention has been made in view of the above circumstances, and an object thereof is to provide a technique that enables a more appropriate search for a counselor regarding a trouble.

### Solution to Problem

In order to solve the above problems, a first aspect of this invention is an information processing apparatus including:
an information acquisition unit that acquires first text information handled in a terminal apparatus used by a first user in response to a search request issued by the first user to search for candidate users from among a plurality of users;
a condition generation unit that divides words included in the first text information into a first word group having an appearance frequency lower than a first threshold and a second word group having an appearance frequency equal to or higher than the first threshold according to an appearance frequency in second text information related to past work of the first user;
a search processing unit that
extracts the candidate users from among the plurality of users according to an appearance frequency of a word belonging to the first word group in third text information related to past work of each user, and
determines manuals referred to in past by each of the extracted candidate users and calculates priority of each candidate user such that the higher the appearance frequency of the word belonging to the first word group in the manuals, the higher the priority; and
a result output unit that outputs information for presenting information regarding the candidate users including the priority to the first user.

### Advantageous Effects of Invention

According to the first aspect of this invention, text information handled in a terminal apparatus used by a first user is acquired in response to a search request from the first user. Words included in the text information are divided according to the appearance frequency in second text information related to past work of the first user. A word having a low appearance frequency in the second text information related to the past work of the first user can be paraphrased as a word less familiar to the first user or a word for which the first user requires information. Such a word having a low appearance frequency in the second text information related to the past work of the first user among the words in the text information handled by the first user in the terminal apparatus is used to extract candidate users based on the appearance frequency in the second text information related to past work of search target users. Then, manuals referred to in the past by each of the extracted candidate users are determined, and the priority of each candidate user is calculated such that the higher the appearance frequency of the word belonging to the first word group in the manuals, the higher the priority.

As described above, since the candidate users are extracted according to the appearance frequency of the necessary information in the third text information related to the past work of the search target users, it is not necessary to tag the search target users in advance. In addition, since the search is made based on the information estimated to be useful for the first user in consideration of the experience of the first user, a more appropriate search result can be obtained. Further, since there is no need to input a search query, it is highly convenient for the first user, and it is possible to flexibly make a search reflecting the current situation without being bound by a specific keyword. Then, the priority of each candidate user is calculated such that the higher the appearance frequency of the word belonging to the first word group in the manuals referred to in the past by the extracted candidate users, the higher the priority, and therefore, a user who has general knowledge (meaning and reason of each work) or who has been aware of general information can be preferentially selected as a counselor, and the possibility of solving the trouble is further increased.

That is, according to the first aspect, it is possible to provide a technique that enables a more appropriate search for a counselor regarding the trouble.

### BRIEF DESCRIPTION OF DRAWINGS

FIG. 1 is a diagram illustrating an example of an overall configuration of a search system including a search server as an information processing apparatus according to a first embodiment of this invention.

FIG. 2 is a schematic diagram illustrating an outline of processing of the search server illustrated in FIG. 1.

FIG. 3 is a schematic diagram illustrating an outline of processing up to extraction of a counselor candidate with a degree of recommendation illustrated in FIG. 2.

FIG. 4 is a block diagram illustrating an example of a functional configuration of the search server as the information processing apparatus according to the first embodiment.

FIG. 5 is a block diagram illustrating an example of a hardware configuration of the search server illustrated in FIG. 4.

FIG. 6 is a flowchart illustrating an outline of processing by the search server illustrated in FIG. 4.

FIG. 7 is a flowchart illustrating an example of a procedure of terminal handling content grasping processing in the processing illustrated in FIG. 6.

FIG. 8 is a diagram illustrating an example of text information acquired by the processing illustrated in FIG. 7.

FIG. 9 is a diagram illustrating an example of data stored in the processing illustrated in FIG. 7.

FIG. 10 is a flowchart illustrating an example of a procedure of pairing condition generation processing in the processing illustrated in FIG. 6.

FIG. 11 is a schematic diagram illustrating a first example of determination processing in the processing illustrated in FIG. 10.

FIG. 12 is a schematic diagram illustrating a second example of the determination processing in the processing illustrated in FIG. 10.

FIG. 13 is a diagram illustrating an example of data stored in the processing illustrated in FIG. 10.

FIG. 14 is a flowchart illustrating an example of a procedure of pairing processing in the processing illustrated in FIG. 6.

FIG. 15 is a flowchart illustrating an example of a procedure of processing of counting manuals reference count of a worker illustrated in FIG. 14.

FIG. 16 is a diagram illustrating an example of data stored in the processing illustrated in FIG. 14.

FIG. 17 is a flowchart illustrating an example of a procedure of pairing result output processing in the processing illustrated in FIG. 6.

FIG. 18 is a schematic diagram illustrating an outline of processing of a search server as an information processing apparatus according to a second embodiment of this invention.

FIG. 19 is a flowchart illustrating an example of a procedure of pairing processing according to the second embodiment.

FIG. 20 is a flowchart illustrating an example of a procedure of counselor candidate extraction processing illustrated in FIG. 19.

FIG. 21 is a flowchart illustrating an example of a procedure of counselor candidate narrowing-down processing illustrated in FIG. 19.

### DESCRIPTION OF EMBODIMENTS

Embodiments according to this invention will be described below with reference to the drawings. Note that, hereinafter, the same or similar reference signs will be given to components that are the same as or similar to those already described, and redundant description will be basically omitted. For example, in a case where there is a plurality of same or similar components, a common sign may be used to describe each component without distinguishing the components, or a branch number may be used in addition to the common sign to distinguish and describe each component.

### First Embodiment

### (1) Configuration

### (1-1) Search System

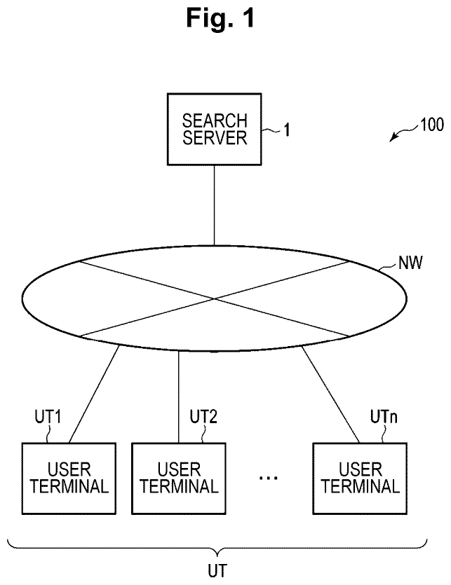

FIG. 1 is a diagram illustrating an example of an overall configuration of a search system 100 including an information processing apparatus according to a first embodiment of this invention. The search system 100 includes a search server 1 and user terminals UT1, UT2, . . . , UTn (hereinafter, collectively referred to as “user terminals UT”) that can communicate with each other via a network NW.

The information processing apparatus according to the first embodiment can be implemented as the search server 1. The search server 1 is, for example, a server computer or a personal computer managed by a group such as a company, a school, a union, or a membership community.

The search server 1 communicates with each of the user terminals UT to perform processing of accepting a request from a user in trouble (hereinafter, referred to as “counselee” or “counseled user”), searching for candidates for a user with whom the counseled user takes counsel (hereinafter, referred to as “counselor” or “counseling user”), and presenting a search result to the counseled user. The search server 1 can also notify the counseling user the fact that the counseling user has been extracted as a candidate, the fact that the trouble has occurred, information of the counseled user, or the like. As described above, the search server 1 recommends a user as a counselor candidate to a counseled user, and makes the user as the counselor candidate realize the occurrence of a trouble, thereby providing assistance for linking (here, referred to as “pairing”) the counseled user and the counseling user.

The network NW may be, for example, the Internet, an intranet, a local area network (LAN), a wide area network (WAN), or the like, and may include a wired or wireless network.

Each of the user terminals UT is an information processing terminal used by a user, and is, for example, a personal computer, a smartphone, a tablet terminal, a mobile phone, or the like. Users belong to a group as described above that manages the search server 1 can perform work or the like using the user terminals UT and can also communicate with other users via the user terminals UT. Each of the user terminals UT may be a dedicated terminal of a user or may be a terminal shared among a plurality of users.

Hereinafter, as an example, a situation will be described in which each user as a worker belonging to a company uses the search system 100 using a corresponding one of the user terminals UT. Note that the search server 1 may be an apparatus separate from the user terminals UT or may be integrated with one of the user terminals UT.

As described above, in the recent work environment, skill sets possessed by users are diversified, and it is becoming difficult to naturally find out “what each user is familiar with”, “who is in trouble”, “what is the trouble”, and the like in everyday life. Therefore, when a trouble that requires counsel with another person occurs, a user who wants to take counsel needs to search for a counselor having experience of the trouble. At the time of occurrence of such a trouble, the search server 1 attempts to allow both the counselee and the counselor to mutually find a person who can share a “work situation at the time of occurrence of the trouble” and a “solution in accordance with the situation” with minimum effort (including explanation).

In a conventional method, content having a mechanism for explicitly holding creators of created/registered documents (e-mail, web page, office document, or the like) or the like is accumulated, and a person who wants to find an expert inputs a search query or a keyword, thereby extracting a creator/user of content including the keyword. Here, in order to make a search, it is necessary to actively tag each work experience (for example, “#reception”, “#development”, and “#budget management”) to a corresponding person in order to clarify on the system what kind of knowledge each person has. Alternatively, a mechanism for automatically tagging each work experience to a corresponding person is required, and a technique for the automatic tagging is required.

In addition, in the conventional method, when a counselor is extracted by use of a keyword, description contents of a document created/registered by a counselor candidate or description contents of an e-mail transmitted or received by the counselor candidate are used as information regarding experience of the counselor candidate. However, in this case, a person who possesses experience regarding a certain keyword is limited to a creator/registrant of a document except for a transmitter and a receiver of an e-mail.

For example, in a case where a trouble occurs at the time of using a work system, documents including vocabulary “related to the trouble and the work situation (such as display contents of a work system screen)” used as a search keyword are mainly documents created/registered by a work system provider, such as a use manual of the work system, and few documents are created/registered by users. Therefore, the provider of the work system is more likely to be extracted as a counselor than a user of the work system. However, the provider of the work system does not always perform work as a user. In addition, even if the trouble occurs at the time of using the work system, the trouble does not necessarily relate to a method of using the work system, and may relate to a specific work content that is about to be performed on the work system, which is unknown to the work system provider. For these reasons, the provider of the work system is less likely to have the experience of solving the trouble, but users are more likely to satisfy requirements of the concerned case. Thus, there is a possibility that a person who actually satisfies the requirements of the concerned case is leaked from counselor candidates.

Further, in the conventional method, only a keyword input by a counselee itself is used as a search condition, and a counselor is extracted. It is not considered whether the search keyword relates to a work situation or a trouble, for example, as described below as (Example a) to (Example c).

(Example a) A case where the search keyword selected by the counselee itself is limited to vocabulary related to a work situation: even if a counselor having abundant experience of the same work situation as that of the counselee can be extracted, it is not considered whether the counselor has experience of solving a trouble. Therefore, there is a high possibility that the counselor has no experience of solving the trouble, and in this case, it is not useful for solving the trouble.

(Example b) A case where the search keyword selected by the counselee itself is limited to vocabulary related to a trouble: even if a counselor having abundant experience related to the trouble can be extracted, it is not considered whether the counselor has experience in the same work situation as a work situation in which the counselee faces the trouble. Therefore, there is a high possibility that the counselor does not have experience of the work situation, and in this case, the counselee needs to explain a lot for the counselor to understand the work situation at the time of occurrence of the trouble. Even if the counselor shares its own experience as it is, the experience does not serve as a solution in accordance with the work situation of the counselee, and it is necessary to prepare an explanation in accordance with the work situation of the counselee anew.

(Example c) A case where the search keywords selected by the counselee itself include vocabulary related to both a work situation and a trouble: a search keyword related to the work situation and a search keyword related to the trouble are not distinguished, and, for example, a creator/user of content including more search keywords is extracted as a counselor. Therefore, the extracted counselor is not limited to a creator/user of content including the vocabulary related to the trouble, and the same problem as the above (Example a) occurs.

In view of the above problems, the search server 1 or the search system 100 according to the first embodiment focuses on at least one of the following points.

[Point 1] Text information handled in each of the user terminals UT is acquired in the background, is recorded and accumulated in association with a worker (user), and is used to grasp work experience of each worker.

[Point 2] Work information that is the information the counselee is currently handling (at the time point of consultation) is divided into “trouble information” that is information of a trouble for which the counselee wants to take counsel and “peripheral information” that is information of work the counselee is performing.

[Point 3] Counselor candidates are selected based on work experience related to the trouble information, and a higher degree of recommendation is assigned to a person having more experience related to both the trouble information and the peripheral information.

[Point 4] A higher priority is given to a person who has referred a lot to manuals related to the trouble information and the peripheral information among persons whom a high degree of recommendation is assigned.

[Point 5] Not only the counselee but also all the workers are checked for the status of possession of work experience related to the trouble information and the peripheral information and manuals reference experience. Thus, pairing including not only a viewpoint of the counselee but also a viewpoint of the counselor is achieved.

[Point 6] As a result of the pairing processing, a counselor candidate whom a high priority is given is notified of occurrence of a trouble that the counselor candidate is likely to help to solve based on its own experience.

[Point 7] Regarding the above [Point 1], in addition to the text information handled in the user terminals UT, displayed screen images or paths of used documents are acquired, and are recorded and accumulated in association with the text information. When the counselor candidate accepts a counsel request or receives notification related to the [Point 6], text information including the trouble information and the peripheral information, which serve as pairing conditions, is specified from the accumulated text information, and a screen image and a path associated with the specified text information are displayed.

Note that the manuals are documents including a comprehensive full set of information, such as a manual, a general procedure manual covering work, and a dissemination document. On the other hand, documents unique to each case, explanatory materials including screen capture, development-related documents, research materials, and the like are referred to as case-specific documents in the present embodiment.

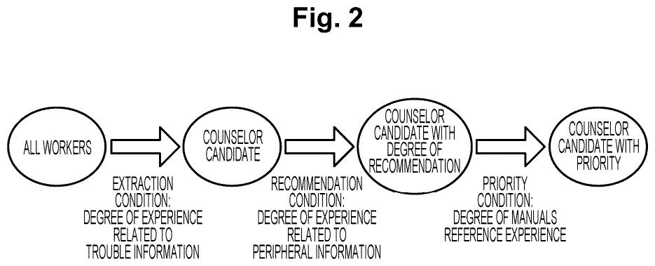

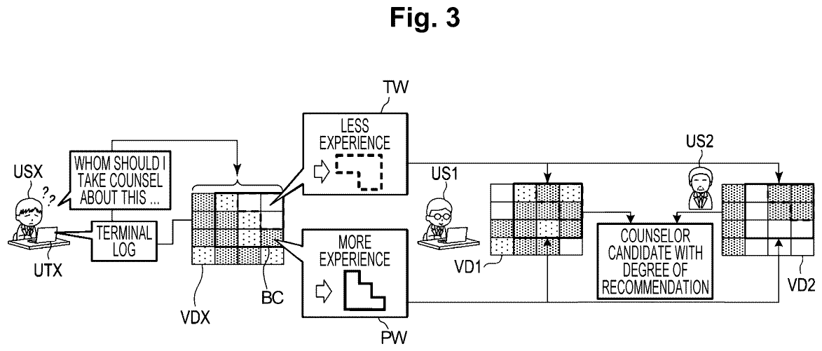

FIG. 2 illustrates an outline of processing of the search server 1 according to the first embodiment. In addition, FIG. 3 illustrates an outline of processing up to extraction of a counselor candidate with a degree of recommendation illustrated in FIG. 2. A counselee (counseled user) USX is in trouble and is worried about who gives counsel. Note that text information handled in a user terminal UTX used by the counselee USX is assumed to be accumulated as work experience (log) in an arbitrary storage unit in advance. When the counselee USX issues a search request to the search server 1 via the user terminal UTX at the time of occurrence of the trouble as illustrated in FIG. 3, the search server 1 acquires text information handled by the user terminal UTX at this time point (or a certain time frame including this time point) as a current work situation BC. The search server 1 compares words (also collectively referred to as “vocabulary” herein) included in the acquired text information with the accumulated work experience, and calculates the appearance frequency in the accumulated work experience. A vocabulary distribution image VDX indicates how frequently each word in the text information acquired as the current work situation appears in the work experience of the counselee USX. Here, an area with a light color has a low appearance frequency, and an area with a dark color has a high appearance frequency.

Based on the appearance frequency, the search server 1 extracts a word with less experience as “trouble information TW” and extracts a word with more experience as “peripheral information PW” among the words included in the current work situation of the counselee USX. The degrees of experience can be determined by use of a threshold designated in advance.

Next, the search server 1 determines degrees of experience of all the workers other than the counselee regarding the trouble information TW and the peripheral information PW. Note that it is assumed that text information handled in the user terminals UT used by these workers is also acquired in advance as work experience and is accumulated in an arbitrary storage unit. Specifically, as illustrated in FIG. 2, the search server 1 extracts counselor candidates having a large experience of using the trouble information TW, that is, having a high degree of experience related to the trouble information TW, from all the workers other than the counselee. Then, for the extracted counselor candidates, the search server 1 assigns a high degree of recommendation to workers who have a large experience related to the peripheral information PW, that is, a high degree of experience related to the peripheral information PW, and selects counselor candidates with a degree of recommendation. In the example of FIG. 3, a user US1 and a user US2 having vocabulary distribution images VD1 and VD2 are selected as counselor candidates with a degree of recommendation. It is determined that the user US1 has sufficient experience related to the peripheral information PW particularly, and it is determined that the user US2 has less experience related to the peripheral information PW but has more experience related to the trouble information TW.

Next, as illustrated in FIG. 2, the search server 1 gives a high priority to workers who have referred to related manuals a lot, that is, have a high degree of manuals reference experience, among the selected counselor candidates with a degree of recommendation, and narrows down the counselor candidates with priority.

In a counselee pairing technique in which workers having a high degree of experience related to the trouble information TW of the counselee USX are defined as “counselor candidates”, and when the counselor candidates are ranked, workers having a high degree of experience related to the peripheral information PW are defined as a high rank, and “counselor candidates with a degree of recommendation” are merely narrowed down, simply a worker having handled the vocabulary of the peripheral information PW a lot is selected as a counselor. However, the counselee does not simply want to select a person who has performed a series of work of the trouble of the counselee many times as the counselor, but desires to select a person who has general knowledge and who is likely to know a coping method even in a case where the person itself does not respond. Therefore, in the present embodiment, workers who know the work variation and have general knowledge, that is, persons who have viewed the manuals are selected as the counselor candidates with priority as persons who have viewed or know the documents “made to be viewed by a large and wide range of people and to be useful”.

In the following description, for convenience, among all the workers (all users) who use the search system 100, a counselee (counseled user) is represented as USX to be distinguished from the workers other than the counselee. Similarly, among all the user terminals UT, a user terminal used by a counseled user USX is represented as UTX. However, as understood, the counseled user USX and the user terminal UTX do not refer to any fixed user or user terminal, and may be replaced with another user or user terminal at any time according to an occurrence situation of a trouble. Hereinafter, simply referring to the user terminals UT may include the user terminal UTX.

### (1-2) Search Server

### (1-2-1) Functional Configuration

Next, a configuration of the search server 1 according to the first embodiment will be described.

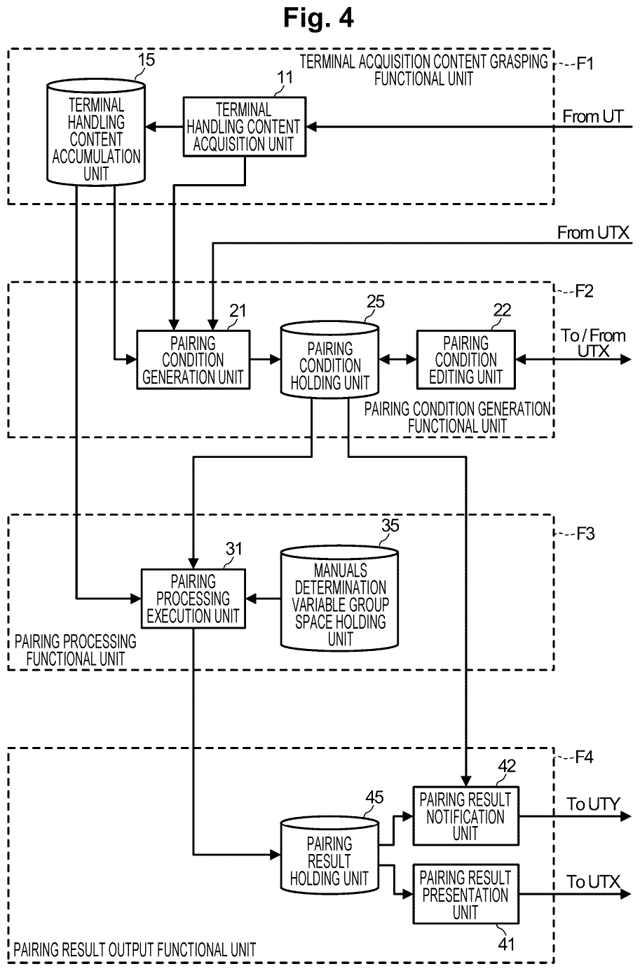

FIG. 4 illustrates a functional configuration example of the search server 1. In FIG. 4, the search server 1 includes a terminal acquisition content grasping functional unit F1 that grasps handling contents of the user terminals UT, a pairing condition generation functional unit F2 that generates a pairing condition, a pairing processing functional unit F3 that performs pairing processing, and a pairing result output functional unit F4 that outputs a pairing result.

The search server 1 includes a terminal handling content acquisition unit 11 and a terminal handling content accumulation unit 15 for the terminal acquisition content grasping functional unit F1. In addition, the search server 1 includes a pairing condition generation unit 21, a pairing condition editing unit 22, and a pairing condition holding unit 25 for the pairing condition generation functional unit F2. In addition, the search server 1 includes a pairing processing execution unit 31 and a manuals determination variable group space holding unit 35 for the pairing processing functional unit F3. In addition, the search server 1 includes a pairing result presentation unit 41, a pairing result notification unit 42, and a pairing result holding unit 45 for the pairing result output functional unit F4.

The terminal handling content acquisition unit 11 performs processing of acquiring text information handled in the user terminals UT including the user terminal UTX. The terminal handling content acquisition unit 11 can acquire text information displayed on a screen of each of the user terminal UT by using, for example, UI Automation (hereinafter, expressed as “UIA”), Microsoft Active Accessibility (hereinafter, expressed as “MSAA”), or an interface independently provided by a program operating in the user terminal UT. Alternatively, the terminal handling content acquisition unit 11 may acquire the information by converting the image displayed on the screen of each user terminal UT into text using a character recognition technique. In addition, when a document is displayed on the screen of the user terminal UT, the terminal handling content acquisition unit 11 may acquire text information from metadata of the document. The document may include not only a case-specific document such as an e-mail, a web page, or an office document but also manuals. Further, the terminal handling content acquisition unit 11 may acquire the information by converting a voice signal input and output by each user terminal UT into text using a voice recognition technique or the like. The terminal handling content acquisition unit 11 acquires the text information by converting electronic data into text by applying the existing techniques to various data formats. The text information acquired by the terminal handling content acquisition unit 11 is stored in the terminal handling content accumulation unit 15 or is passed to the pairing condition generation unit 21 for cooperation. As an option, the terminal handling content acquisition unit 11 may acquire, together with the text information, a screen image of the entire screen or a window from which the text information is acquired and a path of the document. The terminal handling content acquisition unit 11 can acquire the handling contents not only from the user terminal UTX used by the counselee USX but also from the user terminals UT used by the users other than the counselee.

The terminal handling content accumulation unit 15 has a function of holding the text information handled in the user terminals UT, which is acquired by the terminal handling content acquisition unit 11, with distinction between the workers. The terminal handling content accumulation unit 15 may hold the acquired text information as it is, or may hold the text information in a processed form such as an appearance frequency distribution of words included in the text information. As an option, the terminal handling content accumulation unit 15 may also hold the screen image of the entire screen or the window from which the text information is acquired, the path of the document, and the like.

In response to the reception of trouble occurrence information transmitted from the user terminal UTX in response to the counselee's report operation of the trouble occurrence, the pairing condition generation unit 21 compares text information handled in the user terminal UTX at the time of occurrence of a trouble, which is acquired by the terminal handling content acquisition unit 11, with the text information accumulated in the terminal handling content accumulation unit 15, and performs processing of extracting words corresponding to the trouble information TW and the peripheral information PW. More specifically, the pairing condition generation unit 21 divides the text information into words, checks the appearance status of each word obtained by the division in the text information accumulated for the counselee itself or another worker, which is accumulated in the terminal handling content accumulation unit 15, and determines whether each word corresponds to the “trouble information TW” or the “peripheral information PW”. The pairing condition generation unit 21 stores a determination result in the pairing condition holding unit 25.

The pairing condition holding unit 25 holds the vocabulary of the trouble information TW and the vocabulary of the peripheral information PW. As an option, the pairing condition holding unit 25 may also hold the text information acquired from the user terminal UTX at the time of occurrence of the trouble and a screen image and a path of the document acquired together with the text information.

The pairing condition editing unit 22 performs processing of displaying, to the counselee, the respective vocabulary of the trouble information TW and the peripheral information PW held in the pairing condition holding unit 25. For example, the pairing condition editing unit 22 generates information for displaying the information held in the pairing condition holding unit 25 on a display unit (such as an integrated or external display) of the user terminal UTX, and transmits the information to the user terminal UTX. The pairing condition editing unit 22 also performs processing of deleting, changing, or adding the respective vocabulary of the trouble information TW and the peripheral information PW according to an operation of the counselee input via the user terminal UTX. The pairing condition editing unit 22 is optional and may be omitted.

The manuals determination variable group space holding unit 35 holds manuals determination variable group space information acquired from the actual manuals in advance. The manuals determination variable group space information is used to determine whether a document from which text information corresponding to the trouble information TW and the peripheral information PW that have caused extraction of each counselor candidate is acquired is manuals, and details thereof will be described below.

The pairing processing execution unit 31 extracts candidates for a counseling user from among the users other than the counseled user according to work experience based on the trouble information TW and the peripheral information PW held in the pairing condition holding unit 25. More specifically, the pairing processing execution unit 31 compares the trouble information TW and the peripheral information PW with the text information accumulated in the terminal handling content accumulation unit 15 in association with each worker to calculate the following evaluation indexes A and B, extracts persons determined to have work experience related to the trouble based on the evaluation index A as counselor candidates, and then performs processing of assigning a higher degree of recommendation to a person whose evaluation index B and evaluation index A are higher as counselor candidates with a degree of recommendation.

Evaluation index A: the possession amount of work experience of each worker regarding the trouble information TW

Evaluation index B: the possession amount of work experience of each worker regarding the peripheral information PW

In addition, the pairing processing execution unit 31 determines whether a document from which text information corresponding to the trouble information TW and the peripheral information PW that have caused extraction of each counselor candidate with a degree of recommendation is acquired is manuals on the basis of the manuals determination variable group space information held in the manuals determination variable group space holding unit 35. Then, the pairing processing execution unit 31 counts the number determined to be the manuals and obtains the manuals reference count. The search server 1 can select counselor candidates with priority obtained by assigning a higher priority to persons who have referred to the manuals a lot on the basis of the manuals reference count.

The pairing result holding unit 45 has a function of holding the counselor candidates with priority extracted by the pairing processing execution unit 31 and respective degrees of recommendation and manuals reference counts. As an option, the pairing result holding unit 45 can also hold the degree of experience possessed by each counselor candidate with priority regarding the trouble and the work situation at the time of occurrence of the trouble such as the appearance frequency of each word in the vocabulary of the trouble information TW and the vocabulary of the peripheral information PW in the accumulated text information for each counselor candidate with priority.

The pairing result presentation unit 41 performs processing of displaying the data held by the pairing result holding unit 45 to the counselee. For example, the pairing result presentation unit 41 generates information for displaying the pairing result on the display unit (such as the integrated or external display) of the user terminal UTX of the counseled user USX and transmits the information to the user terminal UTX. As an option, the pairing result presentation unit 41 may generate display information for starting communication (telephone, e-mail, business chat, or the like) with a counselor candidate with priority when the counselee performs an operation of selecting the counselor candidate with priority, and transmit the display information to the user terminal UTX together.

As a result of execution of the pairing processing by the pairing processing execution unit 31, the pairing result notification unit 42 performs processing of making notification of the occurrence of the trouble to a worker whose rank in the degree of manuals reference experience in descending order is within a threshold designated in advance, among the extracted counselor candidates with priority. For example, the pairing result notification unit 42 determines workers whose ranks are within the threshold as counseling users, which are final counselor candidates, and notifies the user terminals UT of the counseling users of having been extracted as candidates, the occurrence of the trouble, information regarding the counseled user, or the like. As an option, the pairing result notification unit 42 may further make notification of the text information acquired by the terminal UTX of the counselee at the time of occurrence of the trouble and held in the pairing condition holding unit 25, and information for displaying the screen image and the path of the document acquired together with the text information. In addition, as an option, the pairing result notification unit 42 may specify text information including the trouble information TW and the peripheral information PW from among the text information of the final counselor candidates accumulated in the terminal handling content accumulation unit 15, and make notification of a screen image or a path associated with the specified information. Further, as an option, the pairing result notification unit 42 may generate display information for starting communication (telephone, e-mail, business chat, or the like) with the counselee when the final counselor candidates perform an operation of accepting a counsel request, and transmit the display information to the user terminal UT together.

### (1-2-2) Hardware Configuration

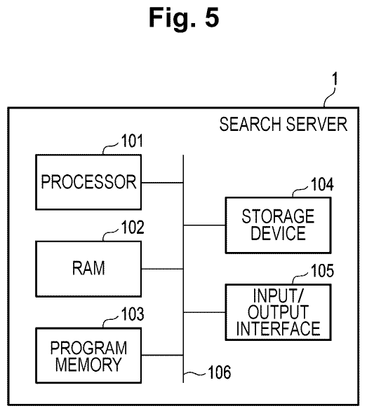

FIG. 5 schematically illustrates a hardware configuration example of the search server 1. As illustrated in FIG. 5, the search server 1 includes a processor 101, RAM 102, program memory 103, a storage device 104, and an input/output interface 105, which are connected to each other via a bus 106. The processor 101 controls the RAM 102, the program memory 103, the storage device 104, and the input/output interface 105, and exchanges signals with these components.

The processor 101 includes a general-purpose circuit such as a CPU. The RAM 102 is used as working memory by the processor 101. The RAM 102 includes volatile memory such as SDRAM. The program memory 103 stores programs executed by the processor 101, which include an information generation program. The programs include computer-executable instructions. For example, ROM is used as the program memory 103.

The processor 101 loads the programs stored in the program memory 103 to the RAM 102, and interprets and executes the programs. When executed by the processor 101, the information generation program can cause the processor 101 to execute the processing functions of the terminal handling content acquisition unit 11, the pairing condition generation unit 21, the pairing condition editing unit 22, the pairing processing execution unit 31, the pairing result presentation unit 41, and the pairing result notification unit 42 described above with respect to the search server 1.

The storage device 104 can function as storage areas of the terminal handling content accumulation unit 15, the pairing condition holding unit 25, and the pairing result holding unit 45 described above. The storage device 104 includes nonvolatile memory such as a hard disk drive (HDD) or a solid state drive (SSD). A partial area of the storage device 104 may be used as the program memory 103.

The input/output interface 105 includes a communication module for communicating with external devices and a plurality of terminals for connecting peripheral devices. The external devices are, for example, the user terminals UT. The communication module may include, for example, a wired module and/or a wireless module. Examples of the peripheral devices include a display, a keyboard, and a mouse.

Note that the processor 101 may include a plurality of processors. In addition, at least a part of the processing functions may be implemented in other various forms including an integrated circuit such as an application specific integrated circuit (ASIC) or a field-programmable gate array (FPGA). At least a part of the storage areas of the storage device 104 may be provided in an apparatus different from the search server 1.

### (2) Operation

### (2-1) Preliminary Preparation

As an index for determining whether a document is manuals or a case-specific document, the following explanatory variables (groups) are provided.

Explanatory variable group V₁: matching rate with manual format

Explanatory variable V₂: range of file user

Explanatory variable group V₃: use period, use frequency, and the like in the file

Here, the explanatory variable group V₁ is a value obtained by counting the number of appearances of words such as “update history”, “version number”, and “reviser” that frequently appear in a manual or the like.

The explanatory variable V₂ indicates, by a numerical value, across how many organizations the file is used. If the value is large, the document is used by a plurality of organizations, and there is a high possibility that the document is manuals.

The explanatory variable group V₃ indicates, by a numerical value, the use period, the number of times of use, the use frequency, and the periodicity. For example, the use period indicates how long it is used, the number of days, or the number of years, and the number of times of use indicates the number of times of being viewed. The use frequency indicates the number of times of being viewed in a period such as one month, and the periodicity may be the number of peaks in the number of times of use every month or every three months (Q).

These three explanatory variables (groups), that is, the explanatory variable group V₁, the explanatory variable V₂, and the explanatory variable group V₃ are considered together regarding a document to be determined whether it is a manuals or a case-specific document, and the following is calculated.

Determination variable group=(explanatory variable group V₁, explanatory variable V₂, and explanatory variable group V₃) This determination variable group is used to determine whether the document is manuals or a case-specific document.

As preliminary preparation for this, actual data is read to grasp in advance what kind of distribution (space) the determination variable group of the actual manuals and what kind of distribution (space) the determination variable group of the actual case-specific document is. That is, a large number of actual manuals and case-specific documents are prepared, and distributions of the determination variable group of the manuals and the determination variable group of the case-specific documents are calculated and statistically analyzed. Then, the manuals and the case-specific documents are clustered. Hereinafter, the determination variable group space of the manuals is α, and the determination variable group space of the case-specific document is β. The information regarding the clustered manuals determination variable group space α and case-specific document determination variable group space β is held in the manuals determination variable group space holding unit 35.

### (2-2) Outline of Entire Operation

Next, an information processing operation by the search server 1 as the information processing apparatus according to the first embodiment configured as described above will be described.

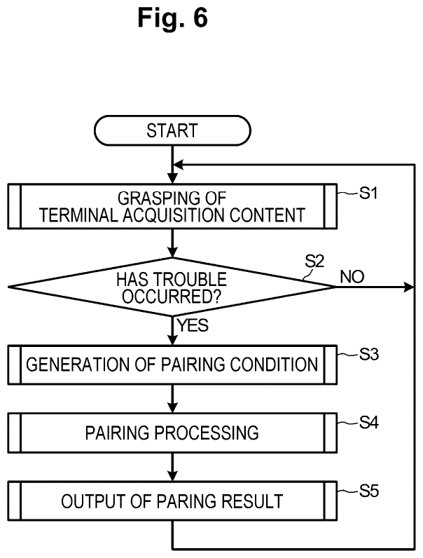

FIG. 6 is a diagram illustrating an outline of the information processing operation.

In step S1, the search server 1 performs terminal handling content grasping processing. The terminal handling content grasping processing includes acquiring text information (first text information) handled in the user terminal UTX in response to a search request issued by a counselee (first user) when a trouble occurs. The terminal handling content grasping processing may further include acquisition of text information (second text information) as work experience of the counselee in the counseled user terminal UTX and acquisition of text information (third text information) as work experience in all the user terminals UT except for the counseled user terminal UTX.

In step S2, the search server 1 monitors occurrence of a trouble. If it is determined in step S2 that no trouble has occurred, the processing proceeds to step S1, and if it is determined that a trouble has occurred, the processing proceeds to step S3. The search server 1 executes subsequent processing, which is triggered by, for example, issuance of a search request for searching for a counselor from any of the user terminals UT. The search request is transmitted from the user terminal UTX to the search server 1, for example, when a counseled user presses a “counsel button” displayed as a GUI on the display of the user terminal UTX.

In step S3, the search server 1 performs pairing condition generation processing. The pairing condition generation processing includes processing of dividing words included in the acquired first text information into a first word group having an appearance frequency lower than a predetermined threshold and a second word group having an appearance frequency equal to or higher than the predetermined threshold according to the appearance frequency in the second text information. The first word group corresponds to the “trouble information TW” and includes words less familiar to the counselee. The second word group corresponds to the “peripheral information PW”. Note that, here, the “appearance frequency” is calculated as a value obtained by dividing the number of times a certain word appears in the text information to be compared by the total number of all words included in the text information to be compared. In the example of step S3, the number of times each word included in the acquired first text information appears in the second text information is calculated, and the number of appearances is divided by the total number of all the words included in the second text information, so that the appearance frequency is calculated.

In step S4, the search server 1 performs pairing processing. The pairing processing includes processing of regarding the appearance frequency of each of the trouble information TW and the peripheral information PW as a degree of work experience, extracting candidates for a counseling user from the users other than the counseled user, and calculating respective degrees of recommendation. In addition, the pairing processing includes processing of determining whether a document in which the trouble information TW and the peripheral information PW appear is manuals, and counting the reference counts of the manuals.

In step S5, the search server 1 outputs the pairing result. The output of the pairing result includes processing for displaying the pairing result to the counseled user and the counseling users.

Hereinafter, step S3 will be described in more detail. Hereinafter, the description will be given by use of the following items:
A set of all workers (including a counselee and a counselor): K
A set of records of each worker k (∈K): Lₖ
A set of vocabulary included in the trouble information TW (trouble information vocabulary set): T
A set of vocabulary included in the peripheral information PW (peripheral information vocabulary set): C.

The search server 1 calculates an appearance frequency: m_{i,k} of each word tᵢ included in the trouble information vocabulary set T from an appearance frequency distribution of the vocabulary. After that, the following values are calculated as the “possession amount of work experience related to the trouble information TW”.

$$\begin{matrix}Coverage degree of trouble information : \\ {g}_{k} = \frac{\vert \{ {t}_{i} \vert {m}_{i , k} > 0 \} \vert}{\vert T \vert}\end{matrix} \qquad [ Math . 1 ]$$

$$\begin{matrix}Handling degree of trouble information : \\ {\overline{m}}_{k} = \frac{1}{\vert T \vert} {\sum }_{{t}_{i} ∈ T} {m}_{i , k}\end{matrix}$$

The coverage degree of the trouble information TW indicates, in other words, a percentage of words existing in the records of each worker among the words belonging to the first word group (vocabulary of the trouble information TW). The handling degree of the trouble information TW indicates, in other words, a value obtained by dividing the sum of frequencies at which the words belonging to the first word group appear in the records of each worker by the total number of the words belonging to the first word group.

In addition, the search server 1 calculates an appearance frequency n_{j,k} of each word cⱼ included in the peripheral information vocabulary set C from an appearance frequency distribution of the vocabulary. After that, the following values are calculated as the “possession amount of work experience related to the peripheral information PW”.

$$\begin{matrix}Coverage degree of peripheral information : \\ {h}_{k} = \frac{\vert \{ {c}_{j} \vert {n}_{j , k} > 0 \} \vert}{\vert C \vert}\end{matrix} \qquad [ Math . 2 ]$$

$$\begin{matrix}Handling degree of peripheral information : \\ {\overline{n}}_{k} = \frac{1}{\vert C \vert} {\sum }_{{c}_{j} ∈ C} {n}_{j , k}\end{matrix}$$

The coverage degree of the peripheral information PW indicates, in other words, a percentage of words existing in the records of each worker among the words belonging to the second word group (vocabulary of the peripheral information PW). The handling degree of the peripheral information PW indicates, in other words, a value obtained by dividing the sum of frequencies at which the words belonging to the second word group appear in the records of each worker by the total number of the words belonging to the second word group.

Further, the search server 1 extracts the counselor candidates from the set K by using the “possession amount of work experience related to the trouble information TW”, calculates the following “degree of recommendation rₖ” for each counselor candidate k by using the “possession amount of work experience related to the trouble information TW” and the “possession amount of work experience related to the peripheral information PW”, and gives the degree of recommendation rₖ to each counselor candidate k.

$${r}_{k} = γ {g}_{k} + δ {\overline{m}}_{k} + ε {h}_{k} + ζ {\overline{n}}_{k} \qquad [ Math . 3 ]$$

In the above formula, γ, δ, ∈, and ζ are parameters for controlling to what extent each of the evaluation indexes related to the “possession amount of work experience related to the trouble information TW” and the “possession amount of work experience related to the peripheral information PW” are reflected in the degree of recommendation, and are designated in advance by, for example, an administrator or the like of the search server 1.

The degree of recommendation is, in other words, a value obtained by weighting and adding the coverage degree of the trouble information TW, the handling degree of the trouble information TW, the coverage degree of the peripheral information PW, and the handling degree of the peripheral information PW for each counselor candidate k. The degree of recommendation has a higher value as value of the coverage degree of the trouble information TW is higher, the handling degree of the trouble information TW is higher, the coverage degree of the peripheral information PW is higher, and the handling degree of the peripheral information PW is higher.

Note that, for calculating the degree of recommendation, it is not necessary to use all of the coverage degree of the trouble information TW, the handling degree of the trouble information TW, the coverage degree of the peripheral information PW, and the handling degree of the peripheral information PW, and the degree of recommendation may be calculated by use of any one of these. In other words, γ, δ, ε, and ζ may be positive values or zero, and it is sufficient that at least one of γ, δ, ε, and ζ is non-zero.

Hereinafter, the operation of the search server 1 will be described in more detail.

### (2-3) Terminal Handling Content Grasping Processing

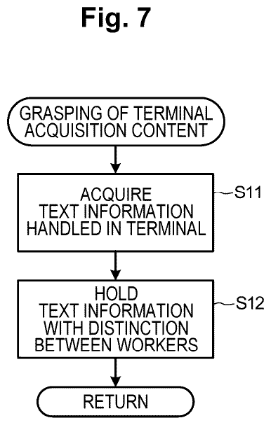

FIG. 7 is a diagram illustrating details of the processing of step S1 illustrated in FIG. 6.

In step S11, the terminal handling content acquisition unit 11 acquires text information handled in each user terminal UT. The text information may be acquired only from a screen displayed to the user on the display of the user terminal UT, or may be acquired from electronic files active on the user terminal, which include a part not displayed on the screen. At this time, as the electronic file, the manuals and the case-specific documents are not distinguished.

As described above, the terminal handling content acquisition unit 11 can acquire the text information displayed on the screen by using UIA, MSAA, or an interface independently provided by a program operating in each of the user terminals UT. Alternatively, the terminal handling content acquisition unit 11 may convert an image displayed on each terminal screen into text by using a character recognition technique, or may convert a voice signal input and output in each user terminal UT into text by using a voice recognition technique or the like. The terminal handling content acquisition unit 11 converts data into text by applying the existing techniques to various data formats, thereby acquiring the text information. As an option, the terminal handling content acquisition unit 11 may acquire, together with the text information, a screen image of the entire screen or a window from which the text information is acquired and a path of the document.

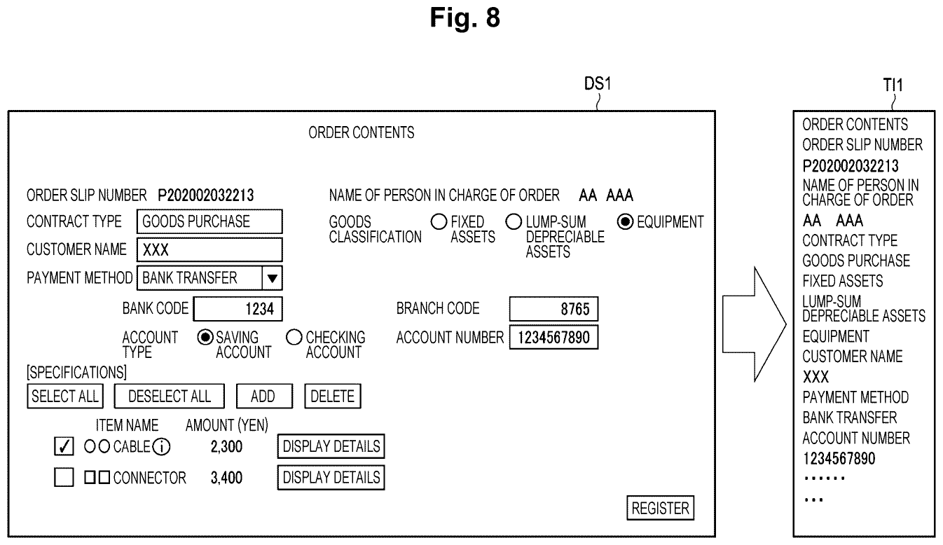

FIG. 8 illustrates an example of text information acquired by the terminal handling content acquisition unit 11. Here, processing of registering order contents on the user terminal UT is performed, and a screen DS1 is obtained by capturing display contents on the display of the user terminal UT at that time. The screen DS1 includes text information such as “order contents” and “order slip number”. Based on the screen display, text information TI1 is acquired as described above.

Next, in step S12 of FIG. 7, the terminal handling content acquisition unit 11 associates the acquired text information with a user ID or the like, to distinguish the worker, and stores the text information in the terminal handling content accumulation unit 15. The text information may also be associated with date-and-time information.

In this manner, the terminal handling content accumulation unit 15 accumulates information each time text information is acquired by the terminal handling content acquisition unit 11. Alternatively, as a premise to start the operation by the search server 1, it may be assumed that a certain amount or more of text information related to all users is accumulated in the terminal handling content accumulation unit 15 in advance regardless of the presence of absence of occurrence of a trouble.

In addition, here, the terminal handling content accumulation unit 15 may hold the text information in a processed form, such as an appearance frequency distribution of vocabulary included in the text information. As an option, the terminal handling content accumulation unit 15 may hold the screen image of the entire screen or the window of each of the user terminals UT from which the text information is acquired and the path of the target document in association with the text information together with the acquisition time. The data may be dispersedly arranged in areas on data storage apparatuses each of which is accessible only by a corresponding one of the workers of the user terminals UT, or the data of all the workers may be collectively arranged in a file server or the like. Alternatively, the arrangement method may be changed according to the type of data, and for example, text information, screen images, and paths of documents may be dispersedly arranged, and only appearance frequency distributions of vocabulary may be collectively arranged.

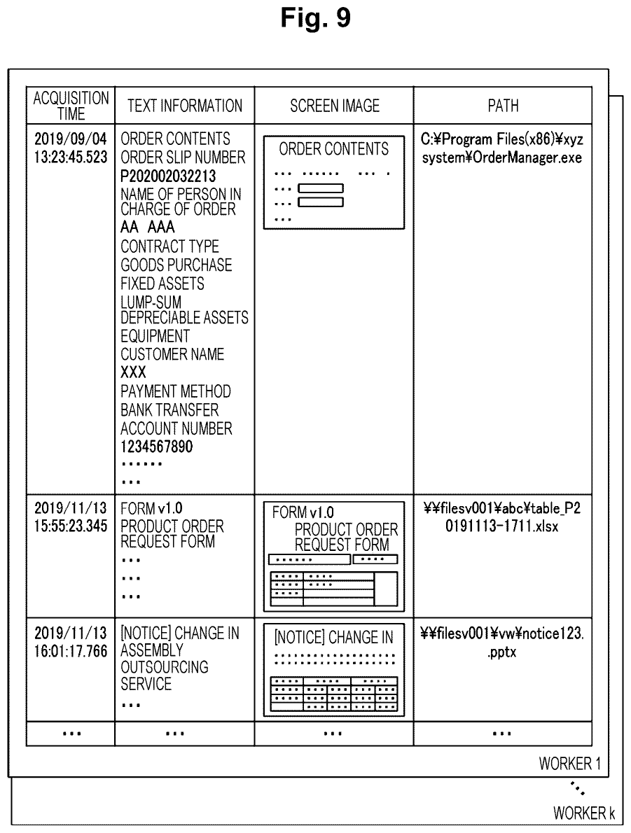

FIG. 9 illustrates an example of data held in the terminal handling content accumulation unit 15. The example of FIG. 9 illustrates an example in which text information is held for each worker (worker 1, . . . worker k) with distinction between acquisition timings. In this example, “acquisition time”, “text information”, “screen image”, and “path” are included as items. However, acquisition and holding of the acquisition time, the screen image, and the path are optional.

### (2-4) Pairing Condition Generation Processing

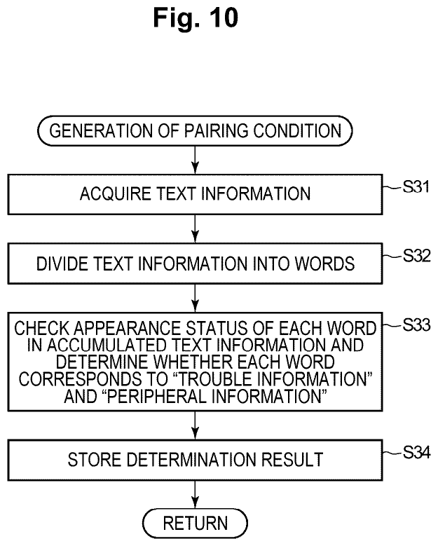

FIG. 10 is a diagram illustrating details of the processing of step S3 illustrated in FIG. 6.

In step S31, the pairing condition generation unit 21 acquires text information acquired by the terminal handling content acquisition unit 11 and handled in the user terminal UTX when the trouble occurs.

In step S32, the pairing condition generation unit 21 divides the acquired text information into morphemes by morphological analysis. Among the morphemes obtained by the division, those having low importance such as postpositional particles may be removed. Alternatively, morphemes may be integrated to form a more complicated word with reference to a dictionary registered in advance. An individual piece of information obtained by the division is referred to herein as a word. Note that the morphological analysis is an example, and the text information may be divided by other methods.

In step S33, the pairing condition generation unit 21 checks the appearance status of each of the obtained words in the text information accumulated in the terminal handling content accumulation unit 15, and determines whether each of the words corresponds to the “trouble information TW” and the “peripheral information PW”. Here, the text information to be compared for each word can be text information accumulated for the counselee itself or another worker. The pairing condition generation unit 21 determines the “trouble information TW” and the “peripheral information PW” by using, for example, the following methods.

### (2-4-1) First Example of Processing of Determining “Trouble Information TW” and “Peripheral Information PW”

### (2-4-1-1) First Step

The number of times each word obtained in step S32 appears in the text information accumulated for the counselee itself, which is accumulated in the terminal handling content accumulation unit 15, is checked to obtain the appearance frequency.

### (2-4-1-2) Second Step

Next, the appearance frequency of each word obtained in the above (2-4-1-1) is compared with a preset threshold, it is determined whether the appearance frequency is high or low, and for example, a word having an appearance frequency equal to or higher than the threshold is determined as “peripheral information PW”, and a word having an appearance frequency lower than the threshold is determined as “trouble information TW”.

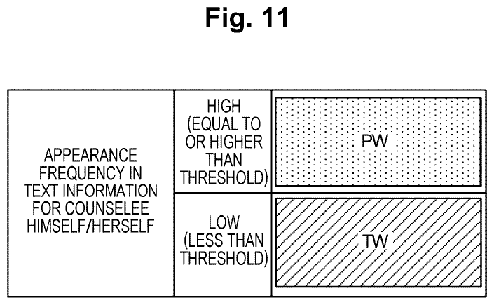

FIG. 11 is a diagram illustrating determination according to the first example. According to the appearance frequency of each word acquired from the terminal UTX of the counselee in the past text information accumulated for the counselee itself, a word having a high appearance frequency is determined as “peripheral information PW”, and a word having a low appearance frequency is determined as “trouble information TW”.

### (2-4-2) Second Example of Processing of Determining “Trouble Information TW” and “Peripheral Information PW”

### (2-4-2-1) First Step

The number of times each word obtained in step S32 appears in the text information accumulated for the counselee itself, which is accumulated in the terminal handling content accumulation unit 15, is checked to obtain the appearance frequency.

### (2-4-2-2) Second Step

The appearance frequency of each word of the counselee itself obtained in the above (2-4-2-1) is compared with a threshold, and it is determined whether the appearance frequency is high or low.

### (2-4-2-3) Third Step

The number of times each word obtained in step S32 appears in the text information accumulated for each of the workers other than the counselee, which is accumulated in the terminal handling content accumulation unit 15, is checked to obtain the appearance frequency.

### (2-4-2-4) Fourth Step

The appearance frequency of each word for each worker obtained in the above (2-4-2-3) is compared with a threshold, and it is determined whether the appearance frequency is high or low.

### (2-4-2-5) Fifth Step

The number of workers determined to be “high” and the number of workers determined to be “low” obtained in the above (2-4-2-4) are counted.

### (2-4-2-6) Sixth Step

Based on the results of the above (2-4-2-2) and (2-4-2-5), it is determined whether each word corresponds to the “trouble information TW” and the “peripheral information PW”. Note that the same value or different values may be used as the thresholds used in (2-4-2-2) and (2-4-2-4).

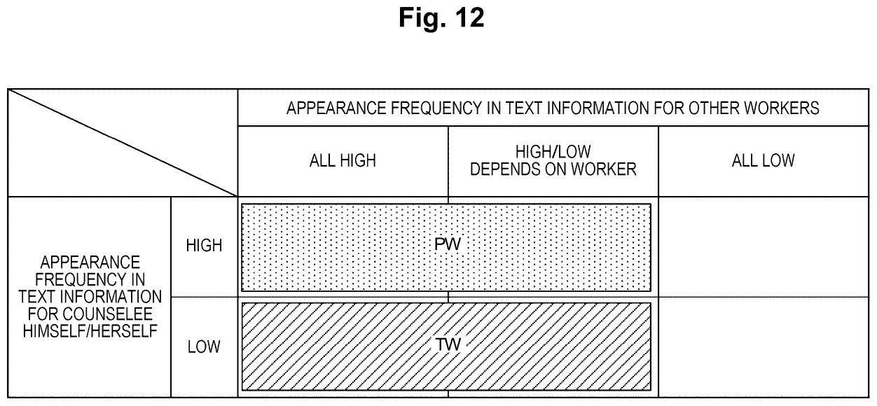

FIG. 12 is a diagram illustrating determination according to the second example. As in the first example, according to the appearance frequency of each word acquired from the terminal UTX of the counselee in the accumulated past text information of the counselee itself, a word having a high appearance frequency is determined as “peripheral information PW”, and a word having a low appearance frequency is determined as “trouble information TW”. However, unlike the first example, words having a low appearance frequency in the text information of all the other workers are excluded from the “peripheral information PW” and the “trouble information TW”. In this manner, excluding the words having a low appearance frequency for all the other workers makes it possible to exclude words that are unique only to the case of occurrence of the trouble throughout the past work of all the workers and are useless in searching for past response cases and response experience (for example, an ID of a new case and the like).

### (2-4-3) Example of Determining Threshold

Note that the thresholds used in the above (2-4-1-2), (2-4-2-2), and (2-4-2-4) can be determined as follows, for example.

[Example 1] A person such as an administrator of the search server 1 designates the thresholds as fixed values in advance.

[Example 2] A statistical value (mean, median, mode, variance, deviation, or the like) of the appearance frequency of the vocabulary in the text information accumulated for the counselee itself is calculated and the thresholds are determined from the statistical value.

[Example 3] A statistical value (mean, median, mode, variance, deviation, or the like) of the appearance frequency of the vocabulary in the text information accumulated for all the workers is calculated and the thresholds are determined from the statistical value.

### (2-4-4) Example of Storage of Determination Result

Next, in step S34 of FIG. 10, the pairing condition generation unit 21 stores the determination result in the pairing condition holding unit 25.

The pairing condition holding unit 25 holds the vocabulary of the trouble information TW and the vocabulary of the peripheral information PW. As an option, the pairing condition holding unit 25 may also hold the text information acquired at the time of occurrence of the trouble and a screen image and a path of the document acquired together with the text information.

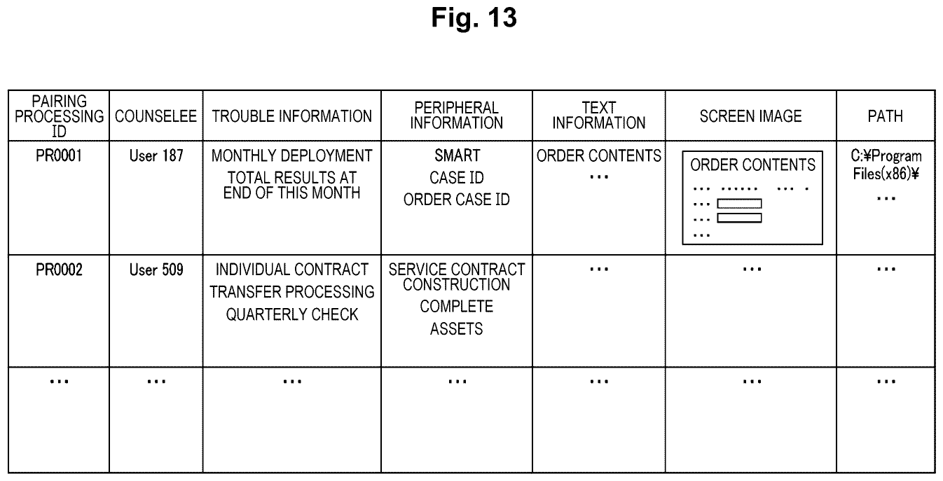

FIG. 13 illustrates an example of data held in the pairing condition holding unit 25. In this example, “pairing processing ID”, “counselee”, “trouble information TW”, “peripheral information PW”, “text information”, “screen image”, and “path” are included as items. Note that “text information”, “screen image”, and “path” are pieces of information having the same item names as the data held in the terminal handling content accumulation unit 15, and are all optional.

In addition, as an option, the information stored in the pairing condition holding unit 25 can be edited by the counselee. As described above, the pairing condition editing unit 22 enables such editing. For example, each time the information held in the pairing condition holding unit 25 is updated or every certain period of time, the pairing condition editing unit 22 generates and transmits information for displaying the respective words of the trouble information TW and the peripheral information PW held in the pairing condition holding unit 25 to the user terminal UTX used by the counselee. When the counselee performs an operation of requesting deletion, change, addition, or the like of a word via the user terminal UTX, the request is transmitted to the search server 1, and the pairing condition editing unit 22 edits the information stored in the pairing condition holding unit 25 in response to the request of the counselee.

### (2-5) Pairing Processing

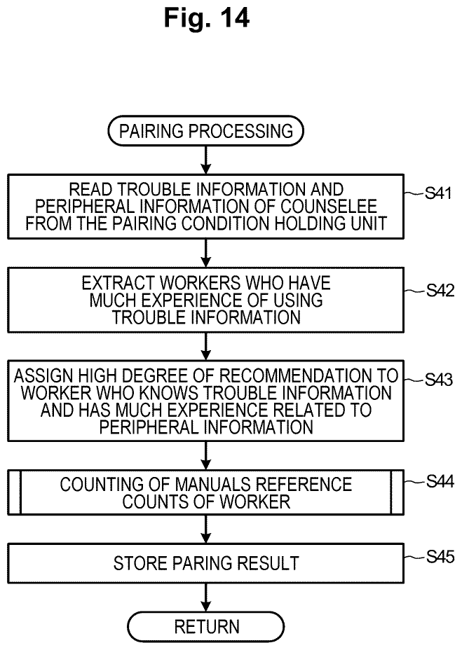

FIG. 14 is a diagram illustrating details of the processing of step S4 illustrated in FIG. 6. This processing is mainly executed by the pairing processing execution unit 31. As described above, the pairing processing execution unit 31 compares the trouble information TW and the peripheral information PW held in the pairing condition holding unit 25 with the text information accumulated in association with each worker to calculate

Evaluation index A: the possession amount of work experience of each worker regarding the trouble information TW, and

Evaluation index B: the possession amount of work experience of each worker regarding the peripheral information PW. Then, the pairing processing execution unit 31 extracts persons determined to have work experience related to the trouble based on the evaluation index A, and then assigns a higher degree of recommendation to a person whose evaluation index B and evaluation index A are higher. Further, the pairing processing execution unit 31 counts the related reference counts of the manuals for each person whom a high degree of recommendation is assigned.

First, in step S41, the pairing processing execution unit 31 reads the trouble information TW and the peripheral information PW of the counselee from the pairing condition holding unit 25.

In step S42, the pairing processing execution unit 31 extracts, as counselor candidates, workers who have much experience of using the trouble information TW based on the evaluation index A.

In step S43, the pairing processing execution unit 31 assigns a high degree of recommendation to workers who know the trouble information TW and who have much experience related to the peripheral information PW.

In step S44, the pairing processing execution unit 31 counts manuals reference counts of the workers who know the trouble information TW and who have much experience related to the peripheral information PW, that is, whom a high degree of recommendation is assigned.

In step S45, the pairing processing execution unit 31 stores the pairing result in the pairing result holding unit 45.

The pairing processing will be described in more detail below. Similar to above, in the following description, following items are used:
A set of workers: K
A set of vocabulary included in the trouble information TW (trouble information vocabulary set): T
A set of vocabulary included in the peripheral information PW (peripheral information vocabulary set): C
   (2-5-1) First Example of Pairing Processing: Example of Processing in Case where Text Information is Held with Distinction Between Acquisition Timings

It is assumed that pieces of text information of each worker accumulated in the terminal handling content accumulation unit 15 are held as different “records” (rows in FIG. 9) according to a difference in acquisition timing. A set of records of each worker k (∈K) is Lₖ.

In the first example, the pairing processing execution unit 31 checks how much trouble information TW and peripheral information PW are included for each record, not for the entire cumulative text information of each worker. Thus, it is possible to consider the experience of handling the trouble information TW and the peripheral information PW at the same timing, that is, how much experience each worker possesses in the same work situation as that of the counselee.

Note that, in a case where a time stamp is given to each record, the timing at which the text information is acquired may be considered, and for example, only records within a certain period from the occurrence of the trouble may be used.

### (2-5-1-1) First Step

The pairing processing execution unit 31 performs the following (i) and (ii) on each record l (∈Lₖ) in the text information of each worker k (∈K), which is accumulated in the terminal handling content accumulation unit 15.

(i) The pairing processing execution unit 31 acquires an appearance frequency m_{i,k,l} of each word tᵢ included in the trouble information vocabulary set T. After that, the following values are calculated.

$$\begin{matrix}Coverage degree of trouble information in record : \\ {g}_{k , l} = \frac{\vert \{ {t}_{i} \vert {m}_{i , k , l} > 0 \} \vert}{\vert T \vert}\end{matrix} \qquad [ Math . 4 ]$$

$$\begin{matrix}Handling degree of trouble information in record : \\ {\overline{m}}_{k , l} = \frac{1}{\vert T \vert} {\sum }_{{t}_{i} ∈ T} {m}_{i , k , l}\end{matrix}$$

(ii) The pairing processing execution unit 31 acquires an appearance frequency n_{j,k,l} of each word cⱼ included in the peripheral information vocabulary set C. After that, the following values are calculated.

$$\begin{matrix}Coverage degree of peripheral information in record : \\ {h}_{k , l} = \frac{\vert \{ {c}_{j} \vert {n}_{j , k , l} > 0 \} \vert}{\vert C \vert}\end{matrix} \qquad [ Math . 5 ]$$

$$\begin{matrix}Handling degree of peripheral information in record : \\ {\overline{n}}_{k , l} = \frac{1}{\vert C \vert} {\sum }_{{c}_{j} ∈ C} {n}_{j , k , l}\end{matrix}$$

### (2-5-1-2) Second Step

The pairing processing execution unit 31 determines whether each record l in the text information of each worker k is a record related to the trouble by comparing the coverage degree g_{k,l} of the trouble information TW in each record with its threshold g* as described below.

### [Math. 6]

In case of g_{k,l}≥g*:

Record is determined as record related to trouble.

In case of g_{k,l}<g*:

Record is determined as not record related to trouble. Set of records satisfying g_{k,l}≥g* is \tilde{L}ₖ.

### (2-5-1-3) Third Step

The pairing processing execution unit 31 performs the following (iii) and (iv) on each worker k.

(iii) The following values are calculated as the “possession amount of work experience related to the trouble information TW”.

$$\begin{matrix}Coverage degree of trouble information : \\ {g}_{k} = \frac{\vert \{ {t}_{i} \vert {\sum }_{l ∈ \tilde{{L}_{k}}} {m}_{i , k , l} > 0 \} \vert}{\vert T \vert}\end{matrix} \qquad [ Math . 7 ]$$

$$\begin{matrix}Handling degree of trouble information : \\ {\overline{m}}_{k} = {\sum }_{l ∈ \tilde{{L}_{k}}} {\overline{m}}_{k , l}\end{matrix}$$

(iv) The following values are calculated as the “possession amount of work experience related to the peripheral information PW”.

$$\begin{matrix}Coverage degree of peripheral information : \\ {h}_{k} = \frac{\vert \{ {c}_{j} \vert {\sum }_{l ∈ \tilde{{L}_{k}}} {n}_{j , k , l} > 0 \} \vert}{\vert C \vert}\end{matrix} \qquad [ Math . 8 ]$$

$$\begin{matrix}Handling degree of peripheral information : \\ {\overline{n}}_{k} = {\sum }_{l ∈ \tilde{{L}_{k}}} {\overline{n}}_{k , l}\end{matrix}$$

### (2-5-1-4) Fourth Step

The pairing processing execution unit 31 determines whether each worker k has work experience related to the trouble based on whether each worker k is determined to have work experience related to the trouble by any one or both of the following conditions ([Math. 10]), using the following ([Math. 9])

\tilde{L}ₖ [Math. 9]

and the “possession amount of work experience related to the trouble information TW”.

### [Math. 10]

Number of records related to trouble is compared with its threshold L*.
In case of |\tilde{L}ₖ|≥L*:
Worker is determined as having work experience related to trouble.
In case of |\tilde{L}ₖ|<L*:
Worker is determined as not having work experience related to trouble.
   Handling degree of trouble information m̅ₖ is compared with its threshold m̅*.
In case of m̅ₖ≥m̅*:
Worker is determined as having work experience related to trouble.
In case of m̅ₖ<m̅*:
Worker is determined as not having work experience related to trouble.

### (2-5-1-5) Fifth Step

The pairing processing execution unit 31 calculates the “degree of recommendation rₖ” for each worker k determined to have work experience related to the trouble in the fourth step of the above (2-5-1-4).

### (2-5-1-5-1) First Example of Method of Calculating Degree of Recommendation

The pairing processing execution unit 31 can calculate the “degree of recommendation rₖ” for each worker k by using the “possession amount of work experience related to the trouble information TW” and the “possession amount of work experience related to the peripheral information PW” as described below.

$${r}_{k} = γ {g}_{k} + δ {\overline{m}}_{k} + ε {h}_{k} + ζ {\overline{n}}_{k} \qquad [ Math . 11 ]$$

However, γ, δ, ε, and ζ are parameters for controlling to what extent each of the evaluation indexes related to the “possession amount of work experience related to the trouble information TW” and the “possession amount of work experience related to the peripheral information PW” are reflected in the degree of recommendation, and are designated in advance by, for example, the administrator or the like of the search server 1 as described above. γ, δ, ε, and ζ may be zero or positive values, and at least one of γ, δ, ε, and ζ is a non-zero value.

### (2-5-1-5-2) Second Example of Method of Calculating Degree of Recommendation

The pairing processing execution unit 31 calculates the following weights for each word tᵢ included in the trouble information vocabulary set T and each word cⱼ included in the peripheral information vocabulary set C. Each of these weights corresponds to an inverse document frequency (IDF) in a case where each record l of the text information accumulated for each worker k is regarded as one document.

$$\begin{matrix}{w}_{i} = - log ( \frac{\vert \{ ( k , l ) \vert {m}_{i , k , l} > 0 \} \vert}{{\sum }_{k ∈ K} \vert {L}_{k} \vert} ) \\ {w}_{j} = - log ( \frac{\vert \{ ( k , l ) \vert {n}_{j , k , l} > 0 \} \vert}{{\sum }_{k ∈ K} \vert {L}_{k} \vert} )\end{matrix} \qquad [ Math . 12 ]$$

The pairing processing execution unit 31 further calculates the following formula as a “weighted possession amount of work experience related to the trouble information TW”.

$$\begin{matrix}Weigthted coverage degree of trouble information : \\ {g}_{k}^{′} = \frac{{\sum }_{{t}_{i} ∈ T} {w}_{i} {μ}_{i , k}}{{\sum }_{{t}_{i} ∈ T} {w}_{i}}\end{matrix} \qquad [ Math . 13 ]$$

$$where$$

$${μ}_{i , k} = \{ \begin{matrix}0 ( when {\sum }_{l ∈ \tilde{{L}_{k}}} {m}_{i , k , l} = 0 ) \\ 1 ( when {\sum }_{l ∈ \tilde{{L}_{k}}} {m}_{i , k , l} > 0 )\end{matrix}$$

$$\begin{matrix}Weigthted handling degree of trouble information : \\ {\overline{m}}_{k}^{′} = \frac{1}{\vert T \vert} {\sum }_{l ∈ \tilde{{L}_{k}}} {\sum }_{{t}_{i} ∈ T} {w}_{i} {m}_{i , k , l}\end{matrix}$$

In addition, the pairing processing execution unit 31 calculates the following formula as a “weighted possession amount of work experience related to the peripheral information PW”.

$$\begin{matrix}Weigthted coverage degree of peripheral information : \\ {h}_{k}^{′} = \frac{{\sum }_{{c}_{j} ∈ C} {w}_{j} {v}_{j , k}}{{\sum }_{{c}_{j} ∈ C} {w}_{j}}\end{matrix} \qquad [ Math . 14 ]$$

$$where$$

$${v}_{j , k} = \{ \begin{matrix}0 ( when {\sum }_{l ∈ \tilde{{L}_{k}}} {n}_{j , k , l} = 0 ) \\ 1 ( when {\sum }_{l ∈ \tilde{{L}_{k}}} {n}_{j , k , l} > 0 )\end{matrix}$$

$$\begin{matrix}Weigthted handling degree of peripheral information : \\ {\overline{n}}_{k}^{′} = \frac{1}{\vert C \vert} {\sum }_{l ∈ \tilde{{L}_{k}}} {\sum }_{{c}_{j} ∈ C} {w}_{j} {n}_{j , k , l}\end{matrix}$$

For each worker k determined to have work experience related to the trouble in the fourth step, the “degree of recommendation rₖ” is calculated as described below.

$${r}_{k} = γ {g}_{k}^{′} + δ {\overline{m}}_{k}^{′} + ε {h}_{k}^{′} + ζ {\overline{n}}_{k}^{′} \qquad [ Math . 15 ]$$

### (2-5-2) Manuals Reference Count Counting

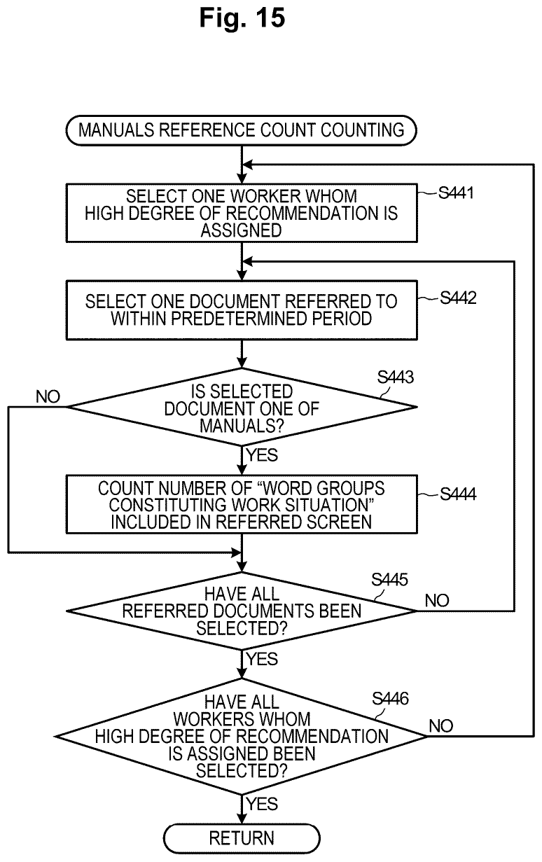

The pairing processing execution unit 31 counts the reference counts of the manuals for the counselor candidates whom a high degree of recommendation is assigned among the respective counselor candidates with a degree of recommendation extracted/calculated as described above. FIG. 15 is a flowchart illustrating an example of a procedure of processing of counting manuals reference count of a worker in step S44 of FIG. 14.

### (2-5-2-1) Processing Target Person Selection

In step S441, the pairing processing execution unit 31 selects one worker whom a high degree of recommendation is assigned from among the counselor candidates with a degree of recommendation. For example, the pairing processing execution unit 31 can rank the workers with a degree of recommendation by the degree of recommendation, and assign the counselor candidates with a degree of recommendation up to a predetermined rank as workers whom a high degree of recommendation is assigned. Alternatively, the pairing processing execution unit 31 can set counselor candidates with a degree of recommendation whose value of the degree of recommendation is equal to or greater than a predetermined value as workers whom a high degree of recommendation is assigned. The predetermined rank and the predetermined value are designated in advance by, for example, the administrator of the search server 1.

### (2-5-2-2) Processing Target Document

In step S442, the pairing processing execution unit 31 selects one document referred to by the selected processing target person within a predetermined period from the terminal handling content accumulation unit 15. This selection can be performed by determining whether the “acquisition time” in the “record” (rows in FIG. 8) that holds the text information of the worker who is the selected processing target person and is accumulated in the terminal handling content accumulation unit 15, is within a predetermined period. The predetermined period is designated in advance by, for example, the administrator of the search server 1.

### (2-5-2-3) Manuals Determination

In step S443, the pairing processing execution unit 31 determines whether the selected document is manuals. In this determination, an explanatory variable (group) is calculated, and a determination variable group is calculated from the calculated explanatory variable (group). Then, it is determined whether the document is manuals based on whether the calculated determination variable group is in a determination variable group space α of the manuals clustered in advance. The pairing processing execution unit 31 proceeds to step S444 when it is determined that the document is manuals, and proceeds to step S445 when it is determined that the document is not manuals.

### (2-5-2-3-1) First Step

The pairing processing execution unit 31 calculates an explanatory variable group V₁ (matching rate with manual format). For example, the pairing processing execution unit 31 can calculate the explanatory variable group V₁ by counting the number of appearances of predetermined words such as “update history”, “version number”, and “reviser” held in the record for the selected processing target document in the terminal handling content accumulation unit 15.

### (2-5-2-3-2) Second Step

The pairing processing execution unit 31 calculates an explanatory variable V₂ (range of file user). For example, the pairing processing execution unit 31 can calculate the explanatory variable V₂ by extracting workers who have used the selected processing target document, determining organizations to which the extracted workers belong, and counting the number of organizations. Whether the processing target document has been used by each worker can be determined by whether the file of the processing target document is recorded in the “path” in the data for each worker in the terminal handling content accumulation unit 15. In addition, the organizations to which workers belong can be determined by referring to affiliation information of the workers accumulated in a user database, which is not illustrated.

### (2-5-2-3-3) Third Step

The pairing processing execution unit 31 calculates an explanatory variable group V₃ (use period, use frequency, and the like in the file). For example, the pairing processing execution unit 31 calculates from when to when the file of the selected processing target document is used, how many times the file is used, the use frequency, e.g., how many times a month, and how many peaks in the number of times of use exists every three months (Q), for example, as the periodicity. The processing target document can also be counted with reference to data for each worker in the terminal handling content accumulation unit 15.

### (2-5-2-3-4) Fourth Step

The pairing processing execution unit 31 considers together the explanatory variable group V₁, the explanatory variable V₂, and the explanatory variable group V₃ calculated in the first to third steps, and calculates the following formula regarding the processing target document.

Determination variable group=(explanatory variable group V₁, explanatory variable V₂, and explanatory variable group V₃)

### (2-5-2-3-5) Fifth Step

The pairing processing execution unit 31 calculates whether the determination variable group of the processing target document calculated in the fourth step is in the determination variable group space α of the manuals, in the determination variable group space β of the case-specific document, or which space is closer in terms of distance although the determination variable group is not in either space. This calculation method is not particularly limited. The pairing processing execution unit 31 determines that the processing target document is a document in a space or a space closer in terms of distance. As described above, the information regarding the determination variable group space α of the manuals and the determination variable group space β of the case-specific document are held in advance in the manuals determination variable group space holding unit 35.

### (2-5-2-4) Counting of Word Groups Constituting Work Situation

In step S444, the pairing processing execution unit 31 counts how many “word groups constituting the work situation” included in the screen that the counselee referred to when the trouble occurs in the processing target document determined to be manuals. The pairing processing execution unit 31 sums up and sets the counted “word groups constituting the work situation” included in the processing target document, that is, the numbers of “word groups included in the trouble information TW” and “word groups included in the peripheral information PW” as the manuals reference count.

### (2-5-2-5) Processing Target Document Update

In step S445, the pairing processing execution unit 31 determines whether all of the documents in the terminal handling content accumulation unit 15 that have been referred to within a predetermined period by the worker selected as the processing target person in step S441 are selected as processing targets. If there is a document that has not yet been selected as a processing target, the pairing processing execution unit 31 proceeds to step S442, selects the unselected document, and repeats the above steps. In addition, when all the documents are selected as the processing targets, the pairing processing execution unit 31 proceeds to step S446.

### (2-5-2-6) Processing Target Person Update

In step S446, the pairing processing execution unit 31 determines whether all the workers whom a high degree of recommendation is assigned have been selected as the processing target persons. If there is a worker who has not yet been selected as the processing target person, the pairing processing execution unit 31 proceeds to step S441, selects the unselected worker, and repeats the above steps. In addition, when all the workers have been selected as the processing targets, the pairing processing execution unit 31 ends the procedure of the processing of counting manuals reference count of a worker in step S44.

### (2-5-3) Storage of Pairing Result

The workers as the counselor candidates with priority extracted/calculated by the pairing processing execution unit 31 as described above and the manuals reference counts and the degrees of recommendation thereof are stored in the pairing result holding unit 45 as a pairing result in step S45 of FIG. 14.

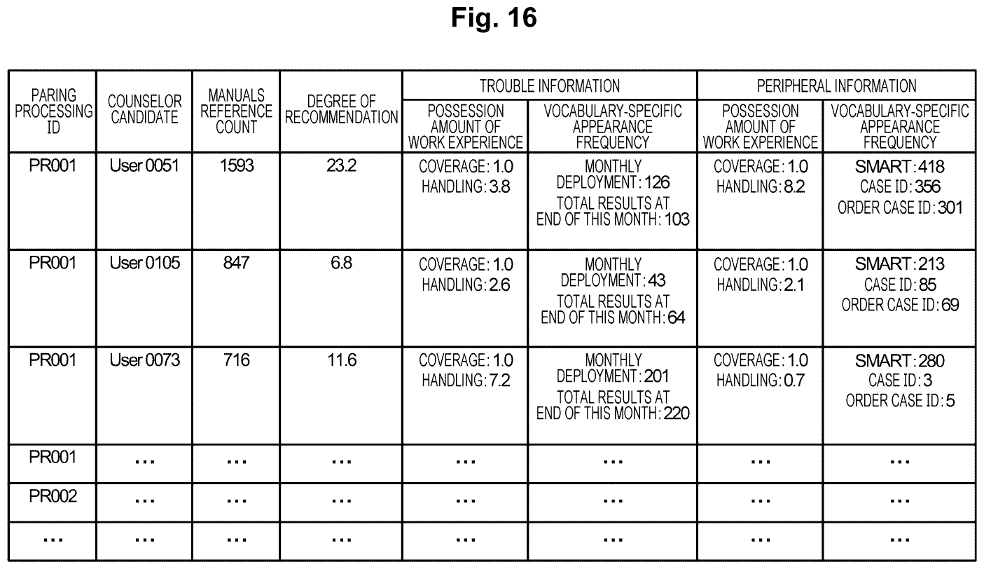

FIG. 16 illustrates an example of information stored in the pairing result holding unit 45.

As illustrated in FIG. 16, the pairing result holding unit 45 holds the “counselor candidates” and their respective “manuals reference counts” and “degrees of recommendation” in association with “pairing processing IDs” for identifying each pairing processing. In the example of FIG. 16, a “counselor candidate” is stored as a user ID, but may be held as a name, a nickname, or the like.

Further, as an option, as illustrated in FIG. 16, the pairing result holding unit 45 can hold the “trouble information TW” and the “peripheral information PW” for each counselor candidate. In the example of FIG. 16, referring to the record of “pairing processing ID=PR0001”, “counselor candidate=User0051” has “manuals reference count=15” and “degree of recommendation=23.2” as a result of calculation, “possession amount of work experience” related to the trouble information TW indicates “coverage=1.0” and “handling=3.8”, the vocabulary-specific appearance frequency indicates “monthly deployment=126” and “total results at end of this month=103”, and similarly “possession amount of work experience” related to the peripheral information PW indicates “coverage=1.0” and “handling=8.2”, and the vocabulary-specific appearance frequency is stored as “SMART=418”, “case ID=356” and “order case ID=301”. Further, as an option, the pairing result holding unit 45 may also hold the appearance frequency of the “trouble information TW” and the “peripheral information PW” in the accumulated text information, the degree of experience of the candidate regarding the trouble and the work situation at the time of occurrence of the trouble, and the like.

### (2-6) Pairing Result Output Processing

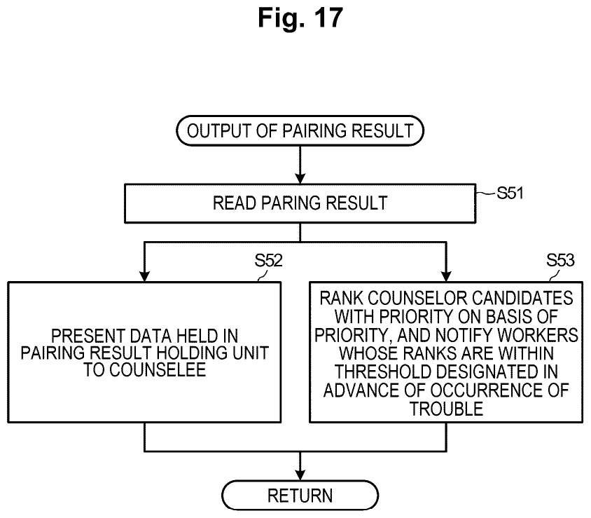

FIG. 17 is a diagram illustrating details of the processing of step S5 illustrated in FIG. 6.

In step S51, the pairing result presentation unit 41 and the pairing result notification unit 42 each read the pairing result stored in the pairing result holding unit 45.

In step S52, the pairing result presentation unit 41 generates and outputs presentation information for presenting the pairing result to the counselee. The output presentation information is transmitted to the user terminal UTX used by the counselee via the network NW, for example. Upon receiving the presentation information, the user terminal UTX generates a corresponding display screen, displays the display screen on a display or the like, and presents the display screen to the counselee. The presentation information may include information for displaying contact information of the counselor candidates with priority on the display screen. As an option, when the counselee selects a counselor candidate with priority via the display screen of the user terminal UTX and the selection operation is accepted, communication (telephone, e-mail, business chat, or the like) to the selected counselor candidate with priority may be started from the user terminal UTX of the counselee. The counselee and the counselor candidate with priority may communicate via the search server 1 or without the search server 1.

In step S53, the pairing result notification unit 42 ranks the counselor candidates with priority on the basis of the priority, and generates and outputs notification information for giving notification of the occurrence of the trouble to “final counselor candidates” who are workers whose ranks in the descending order of the priority are within a threshold designated in advance. The output notification information is transmitted to user terminals UTY, which are user terminals UT used by each of the final counselor candidates, via, for example, the network NW. Upon receiving the notification information, the user terminals UTY generate a corresponding display screen, displays the display screen on a display or the like, and presents the display screen to a corresponding one of the final counselor candidates. As an option, the notification information to be output may include information for displaying the text information acquired by the user terminal UTX of the counselee at the time of occurrence of the trouble and held in the pairing condition holding unit 25 and the screen image, the path of the document, and the like acquired together with the text information. Again, as another option, the notification information to be output may include information for specifying text information including the trouble information TW and the peripheral information PW from among the text information of the final counselor candidates accumulated in the terminal handling content accumulation unit 15, and for displaying a screen image or a path associated with the specified text information.

Further, as an option, when a final counselor candidate accepts a counsel request via the display screen of the user terminal UTY and the accepting operation is accepted, communication (telephone, e-mail, business chat, or the like) with the counselee may be started from the user terminal UTY of the final counselor candidate. Again, the final counselor candidate and the counselee may communicate via the search server 1 or without the search server 1.

Note that steps S52 and S53 may be executed at any timings, and may be executed simultaneously in parallel or may be executed sequentially.

As described above in detail, in the first embodiment of this invention, the first text information handled in the terminal UTX used by the first user (counseled user) USX is acquired in response to the search request for searching for candidate users from among a plurality of users, which is issued by the first user. The appearance frequency of each word included in the first text information in the second text information acquired from the terminal apparatus used by the first user in the past is then calculated. The words included in the first text information are divided into the first word group (trouble information TW) having an appearance frequency lower than a first threshold and the second word group (peripheral information PW) having an appearance frequency equal to or higher than the first threshold according to the appearance frequency in the second text information. Next, the appearance frequency of each word belonging to the first word group in the third text information, which is related to past work of each of the plurality of search target users, is determined, and the candidate users are extracted according to the appearance frequency. Further, the manuals referred to in the past by each of the extracted candidate users are determined, and the priority of each candidate user is calculated such that the higher the appearance frequency of the word belonging to the first word group in the manuals, the higher the priority. Information regarding the candidate users including priority is then presented to the first user, which is the counseled user. In order to extract the candidate users, the appearance frequency of each word belonging to the second word group may further be used. In addition, for the extracted candidate users, the degree of recommendation is calculated on the basis of the appearance frequency of the word in the first word group (trouble information TW) and/or the second word group (peripheral information PW), and the candidate users whom priority is to be given can be narrowed down on the basis of the degree of recommendation. The candidate users can be presented to the counseled user together with the calculated priority or in an order according to the calculated priority. Further, the candidate users can also be notified of information regarding the counseled user, the trouble information TW, or the peripheral information PW.

### (3) Effects

As described above in detail, according to the first embodiment, text information (vocabulary) handled in the work of all the workers is accumulated for each worker, and in a case where a certain person in charge has some trouble during work, for example, the person presses a counsel button on a screen, so that vocabulary in the work screen is extracted, vocabulary of the trouble information TW and the peripheral information PW is determined, and counselors who have experience and have referred to related manuals a lot are searched for and presented to the person in charge. More specifically, in the determination of the trouble information TW and the peripheral information PW, among the vocabulary in the work screen, vocabulary having a small number of appearances in the text information accumulated for the counselee himself (unfamiliar vocabulary for which the counselee has little experience in the past) is determined as the trouble about which the counselee wants to take counsel, and the other vocabulary is determined as the peripheral information PW. In addition, the search for the counselors is to search for, among the workers, counselors having a high coverage degree and a large number of appearances of the trouble vocabulary in the accumulated text information (having much experience of dealing with the trouble of the counselee) and having a high coverage degree and a large number of appearances of the peripheral information PW vocabulary in the accumulated text information (having similar work experience to that of the counselee), and recommend a counselor having a large number of reference counts of the related manuals from the searched counselors. Thus, it is not necessary to tag the work experience, and the search is made in consideration of the background work experience of the counselee and the counselors and general knowledge regarding the work, so that it is possible to recommend more appropriate counselors.

In other words, the search system 100 acquires the text information of the work screen and documents including a case-specific document and manuals handled in each of the user terminals UT in the background, and records and accumulates the text information in association with a corresponding worker (user). The search server 1 uses the accumulated information to grasp the work experience and general knowledge of each worker, which makes it unnecessary to explicitly/actively register (input or tag, for example) the work experience for the purpose of counselee pairing.

In addition, the search server 1 divides text information related to the current work information of the counselee into “trouble information TW” and “peripheral information PW”. Counselor candidates are selected based on work experience related to the trouble information TW, and a higher degree of recommendation is assigned to a person having more experience related to both the trouble information TW and the peripheral information PW. Thus, the determination based on the possession amount of work experience of each worker regarding the trouble information TW serves as an extraction condition, and thus the workers other than those who possesses work experience related to the trouble information TW are excluded from candidates for a counselor. As a result, the candidates are more likely to possess experience of solving the trouble. In addition, the degree of recommendation of each counselor candidate is determined by use of the possession amount of work experience of each worker regarding the peripheral information PW, so that a person who possesses more work experience related to the peripheral information PW is more preferentially recommended as a counselor. As a result, since experienced persons in the same work situation take counsel together,
the counselee does not need to explain a lot for the counselor to understand the work situation at the time of occurrence of the trouble of the counselee, and
the counselor shares its own experience as it is to give a solution in accordance with the work situation of the counselee, which eliminates a need to prepare an explanation in accordance with the work situation of the counselee anew,
for example.

Further, the search server 1 calculates a determination variable group of a document referred to by each counselor candidate with a degree of recommendation, determines whether the document is manuals on the basis of the determination variable group, counts the number of pieces of the trouble information TW and the peripheral information PW included in the document as the manuals reference count if the document is manuals, and gives priority to the counselor candidates with a degree of recommendation according to the manuals reference count. Thus, it is possible to select a person who has general knowledge (meaning and reason of each work) and who seems to know a coping method even in a case where the person itself does not respond instead of a person who has simply performed a series of work of the trouble of the counselee many times, as a counselor candidate with priority, and the possibility of solving the trouble is further increased.

In other words, the search server 1 can determine whether the worker of the user terminal UT has browsed “manuals” by determining whether the document opened in each user terminal UT is manuals or a case-specific document. In this way, the search server 1 can search for a person who knows the meaning and reason of the trouble information TW, and can use the search for ranking the counselor candidates in the counselee pairing technique.

Further, the search server 1 checks status of possession of work experience related to the trouble information TW and the peripheral information PW not only for the counselee but also for all the workers. Thus, pairing including not only a viewpoint of the counselee but also a viewpoint of the counselor is achieved.

Further, as a result of the pairing processing by the search server 1, a final counselor candidate whom high priority is assigned is notified of the occurrence of the trouble that the final counselor candidate is likely to help to solve based on its own experience. Thus, a worker who may be a counselor can easily notice the occurrence of the trouble that the worker is likely to help to solve based on its own experience and knowledge. In addition, the trouble can be easily distinguished from other troubles that are difficult to solve by its own experience and knowledge.

Further, in addition to the text information handled in the counseled user terminal UTX, a screen image and a path of a document are acquired based on information generated by the search server 1, and are recorded and accumulated in association with the text information. When the final counselor candidate accepts a counsel request or receives notification, text information including the trouble information TW and the peripheral information PW, which serve as pairing conditions, is specified from the accumulated text information, and a screen image and a path associated with the specified text information are displayed. If the final counselor candidate can share the specified text information, the screen image, and the path with the counselee without searching for a past document by itself or displaying a past case on the system screen again, it is possible to easily present a solution case experienced by the final counselor candidate to the counselee.

Further, it is not necessary for the counselee to specifically input a text indicating what kind of trouble the counselee is in, and for example, even in a situation where “the trouble cannot be specifically specified” or “the counselee does not understand what the counselee does not understand”, it is possible to present a more appropriate counselor to the counselee.

### Second Embodiment

The same configurations and operations as those of the first embodiment are denoted by the same reference numerals as those of the first embodiment, and the description thereof will be omitted. Hereinafter, differences from the first embodiment will be described.

### (1) Outline of Processing

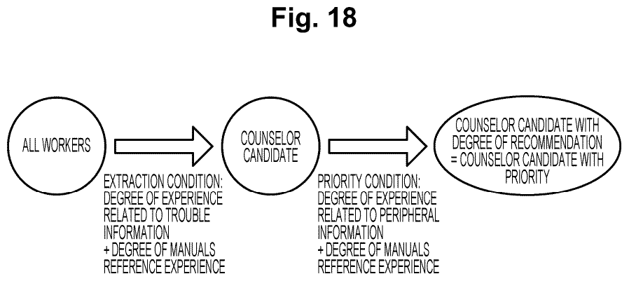

FIG. 18 is a schematic diagram illustrating an outline of processing of the search server 1 according to the present second embodiment.

In the first embodiment, as illustrated in FIG. 2, the search server 1 performs processing of “setting, among the counselor candidates with a degree of recommendation, workers who have referred to manuals including many words constituting the work situation as counselor candidates with priority whom high priority is given” after two pieces of processing of “selecting workers who have used the trouble information TW a lot as counselor candidates” and “selecting, among the counselor candidates, workers who have used the peripheral information PW a lot, as counselor candidates with a degree of recommendation whom a high degree of recommendation is assigned”.

On the other hand, in the present second embodiment, the search server 1 performs processing of “giving a high priority in a case where a document including the trouble information TW is not a case-specific document but manuals” in the processing of “selecting workers who have used the trouble information TW a lot as counselor candidates”, and performs processing of “giving a high priority in a case where a document including the peripheral information PW is not a case-specific document but manuals” in the processing of “selecting, among the counselor candidates, workers who have used the peripheral information PW a lot, as counselor candidates with a degree of recommendation whom a high degree of recommendation is assigned”. In the present second embodiment, the selected counselor candidates with a degree of recommendation are counselor candidates with priority.

### (2) Operation

### (2-1) Pairing Processing

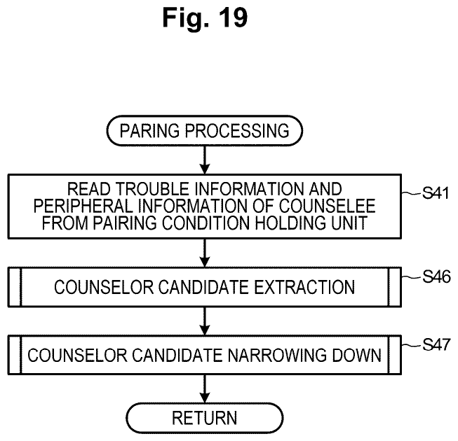

FIG. 19 is a diagram illustrating details of the processing of step S4 illustrated in FIG. 6.

Similarly to the first embodiment, in step S41, the pairing processing execution unit 31 reads the trouble information TW and the peripheral information PW of the counselee from the pairing condition holding unit 25.

Thereafter, in the present second embodiment, in step S46, the pairing processing execution unit 31 performs counselor candidate extraction processing.

In step S47, the pairing processing execution unit 31 performs counselor candidate narrowing-down processing.

### (2-1-1) Counselor Candidate Extraction

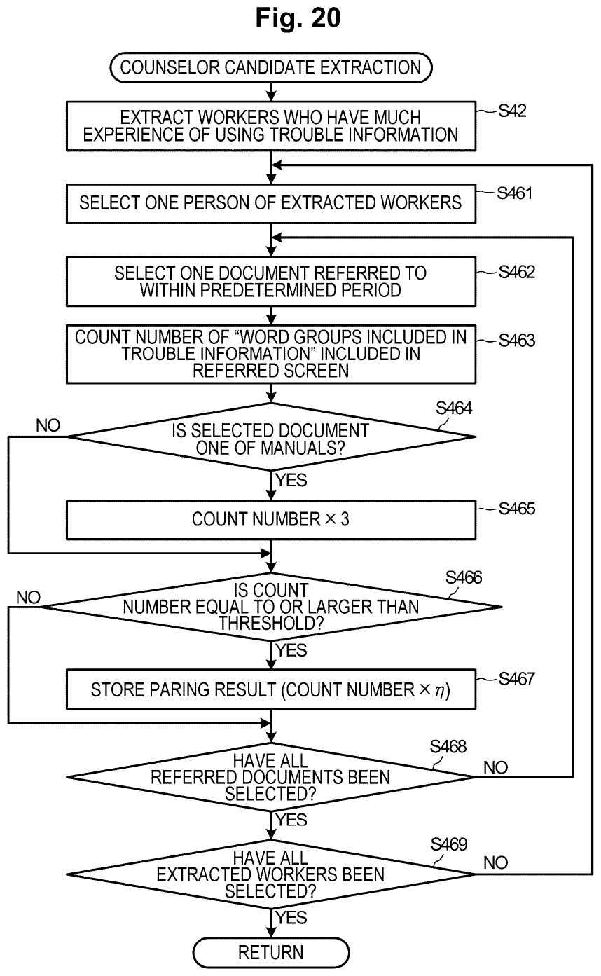

FIG. 20 is a flowchart illustrating an example of a procedure of counselor candidate extraction processing in step S46 of FIG. 19. This counselor candidate extraction processing is processing of “giving a high priority in a case where a document including the trouble information TW is not a case-specific document but manuals” in “selecting workers who have used the trouble information TW a lot as counselor candidates”.

### (2-1-1-1) Processing Target Person Selection

In step S42, the pairing processing execution unit 31 extracts workers who have much experience of using the trouble information TW based on the evaluation index A as described in the first embodiment.

Then, in step S461, the pairing processing execution unit 31 selects one person as the processing target person from among all the extracted workers.

### (2-1-1-2) Processing Target Document

In step S462, the pairing processing execution unit 31 selects one document referred to within a predetermined period by the selected processing target person from the terminal handling content accumulation unit 15.

### (2-1-1-3) Counting of Word Groups Constituting Work Situation

In step S463, the pairing processing execution unit 31 counts how many “word groups included in the trouble information TW” included in the screen that the counselee referred to when the trouble occurs in the selected processing target document.

### (2-1-1-4) Manuals Determination

In step S464, the pairing processing execution unit 31 determines whether the selected processing target document is manuals. As described in the first embodiment, the pairing processing execution unit 31 calculates an explanatory variable (group), calculates a determination variable group from the calculated explanatory variable (group), and determines whether the document is manuals based on whether the calculated determination variable group is in the determination variable group space α of the manuals clustered in advance. Note that the pairing processing execution unit 31 may hold a manuals determination result of each document and use the manuals determination result at the time of manuals determination for another processing target person. That is, it is sufficient that the manuals determination after the determination variable group is calculated is performed only for the documents that have not yet been determined. The pairing processing execution unit 31 proceeds to step S465 when it is determined that the document is manuals, and proceeds to step S466 when it is determined that the document is not manuals.

### (2-1-1-5) Count Number Weighting

In step S465, in a case where the processing target document is manuals, the pairing processing execution unit 31 triples the number of “word groups included in the trouble information TW” in the processing target document counted in step S463. Note that triple is an example, and other values may be used. When the processing target document is not manuals, step S465 is skipped, and thus the count number of the “word groups included in the trouble information TW” in the processing target document remains the counted number.

### (2-1-1-6) Counselor Candidate Determination

In step S466, the pairing processing execution unit 31 determines whether the count number is equal to or higher than a counselor candidate determination threshold. The counselor candidate determination threshold is designated in advance by, for example, the administrator of the search server 1. The pairing processing execution unit 31 sets the selected processing target person as a counselor candidate when the count number is equal to or higher than the counselor candidate determination threshold, and does not set the selected processing target person as a counselor candidate when the count number is less than the counselor candidate determination threshold. The pairing processing execution unit 31 proceeds to step S467 when determining that the count number is equal to or higher than the counselor candidate determination threshold, and proceeds to step S468 when determining that the count number is less than the counselor candidate determination threshold.

### (2-1-1-7) Storage of Pairing Result

In step S467, the pairing processing execution unit 31 stores the pairing result that the processing target person is a counselor candidate in the pairing result holding unit 45. For example, in the example illustrated in FIG. 16, the pairing processing execution unit 31 can store “counselor candidates” and “manuals reference count” in the pairing result holding unit 45 in association with “pairing processing IDs”, and can further store “trouble information TW” as an option. The “manuals reference count” is the count number determined to be equal to or higher than the counselor candidate determination threshold, but the pairing processing execution unit 31 does not hold this count number as it is, but stores a value obtained by multiplying the count number by η as weighting as the “manuals reference count”. The weighting value η is designated in advance by, for example, the administrator or the like of the search server 1 according to how much priority is given to which of the “trouble information TW” and the “peripheral information PW” in selecting the worker as a counselor.

### (2-1-1-8) Processing Target Document Update

In step S468, the pairing processing execution unit 31 determines whether all of the documents in the terminal handling content accumulation unit 15 that have been referred to within a predetermined period by the worker selected as the processing target person in step S461 are selected as processing targets. If there is a document that has not yet been selected as a processing target, the pairing processing execution unit 31 proceeds to step S462, selects the unselected document, and repeats the above steps. In addition, when all the documents are selected as the processing targets, the pairing processing execution unit 31 proceeds to step S469.

### (2-1-1-9) Processing Target Person Update

In step S469, the pairing processing execution unit 31 determines whether all the workers except the counselee have been selected as the processing target persons. If there is a worker who has not yet been selected as the processing target person, the pairing processing execution unit 31 proceeds to step S461, selects the unselected worker, and repeats the above steps. In addition, when all the workers have been selected as the processing targets, the pairing processing execution unit 31 ends the procedure of the counselor candidate extraction processing in step S46. That is, the extraction and prioritization of the counselor candidates according to the trouble information TW are ended.

### (2-1-2) Counselor Candidate Narrowing Down

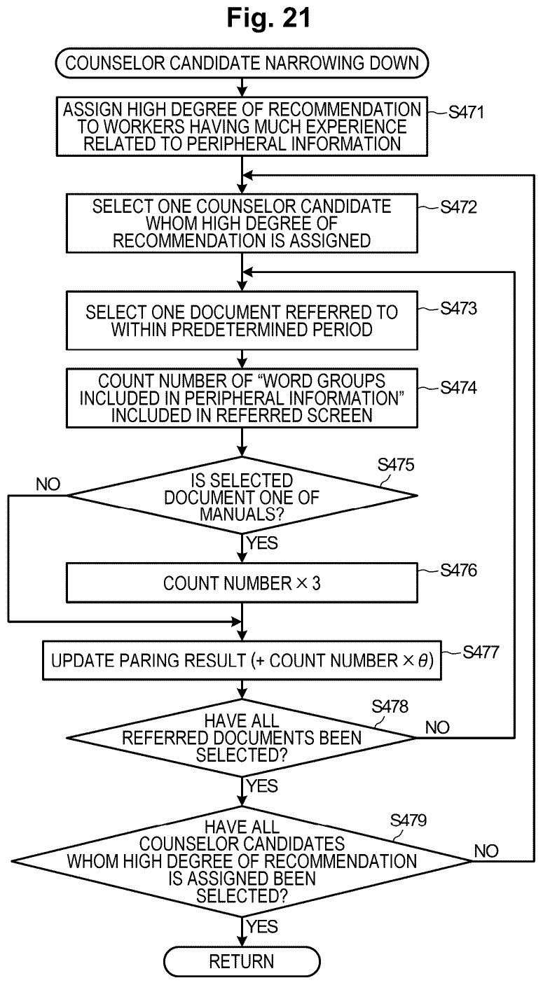

FIG. 21 is a flowchart illustrating an example of a procedure of counselor candidate narrowing-down processing in step S47 of FIG. 19. This counselor candidate narrowing-down processing is processing of “giving a high priority in a case where a document including the peripheral information PW is not a case-specific document but manuals” when “selecting, among the counselor candidates whom a high priority is given, workers who have used the peripheral information PW a lot, as counselor candidates with a degree of recommendation whom a high degree of recommendation is assigned”.

### (2-1-2-1) Degree of Recommendation Assignment

In step S471, as described in the first embodiment, the pairing processing execution unit 31 assigns a high degree of recommendation to workers having a large experience related to the peripheral information PW from among the counselor candidates extracted in the counselor candidate extraction processing in step S46.

### (2-1-2-2) Processing Target Person Selection

In step S472, the pairing processing execution unit 31 selects one counselor candidate whom a high degree of recommendation is assigned.

### (2-1-2-3) Processing Target Document

In step S473, the pairing processing execution unit 31 selects one document referred to within a predetermined period by the selected processing target counselor candidate from the terminal handling content accumulation unit 15.

### (2-1-2-4) Counting of Word Groups Constituting Work Situation

In step S464, the pairing processing execution unit 31 counts how many “word groups included in the peripheral information PW” included in the screen that the counselee referred to when the trouble occurs in the selected processing target document.

### (2-1-2-5) Manuals Determination

In step S475, the pairing processing execution unit 31 determines whether the selected processing target document is manuals. As described in the first embodiment, the pairing processing execution unit 31 calculates an explanatory variable (group), calculates a determination variable group from the calculated explanatory variable (group), and determines whether the document is manuals based on whether the calculated determination variable group is in the determination variable group space α of the manuals clustered in advance. Alternatively, the pairing processing execution unit 31 may hold the manuals determination result in step S464 in the counselor candidate extraction processing in step S46 and refer to the manuals determination result. When it is determined that the document is manuals, the processing proceeds to step S476, and when it is determined that the document is not manuals, the processing proceeds to step S477.

### (2-1-2-6) Count Number Weighting

In step S476, in a case where the processing target document is manuals, the pairing processing execution unit 31 triples the number of “word groups included in the peripheral information PW” in the processing target document counted in step S474. Note that triple is an example, and other values may be used. When the processing target document is not manuals, step S476 is skipped, and thus the count number of the “word groups included in the peripheral information PW” in the processing target document remains the counted number.

### (2-1-2-7) Update of Pairing Result

In step S477, the pairing processing execution unit 31 updates the pairing result of the selected processing target counselor candidates stored in the pairing result holding unit 45. For example, in the example illustrated in FIG. 16, the pairing processing execution unit 31 can update the “manuals reference count” of the “counselor candidate”, store the “degree of recommendation”, and further store the “peripheral information PW” as an option. In updating the “manuals reference count”, the pairing processing execution unit 31 adds a value obtained by multiplying the count number by θ as weighting, instead of adding the count number as it is. The weighting value θ is designated in advance by, for example, the administrator or the like of the search server 1 according to how much priority is given to which of the “trouble information TW” and the “peripheral information PW” in selecting the worker as a counselor.

### (2-1-2-8) Processing Target Document Update

In step S478, the pairing processing execution unit 31 determines whether all of the documents in the terminal handling content accumulation unit 15 that have been referred to within a predetermined period by the counselor candidate selected in step S471 are selected as processing targets. If there is a document that has not yet been selected as a processing target, the pairing processing execution unit 31 proceeds to step S473, selects the unselected document, and repeats the above steps. In addition, when all the documents are selected as the processing targets, the pairing processing execution unit 31 proceeds to step S479.

### (2-1-2-9) Processing Target Person Update

In step S479, the pairing processing execution unit 31 determines whether all the counselor candidates whom a high degree of recommendation is assigned have been selected. If there is a counselor candidate who has not yet been selected as the processing target person, the pairing processing execution unit 31 proceeds to step S471, selects the unselected counselor candidate, and repeats the above steps. In addition, when all the counselor candidates have been selected as the processing targets, the pairing processing execution unit 31 ends the procedure of the counselor candidate narrowing-down processing in step S47. That is, the narrowing down and prioritization of the counselor candidates with a degree of recommendation according to the peripheral information PW are ended.

As described above in detail, in the second embodiment of this invention, the first text information handled in the terminal UTX used by the first user (counseled user) USX is acquired in response to the search request for searching for candidate users from among a plurality of users, which is issued by the first user. The appearance frequency of each word included in the first text information in the second text information acquired from the terminal apparatus used by the first user in the past is then calculated. The words included in the first text information are divided into the first word group (trouble information TW) having an appearance frequency lower than a first threshold and the second word group (peripheral information PW) having an appearance frequency equal to or higher than the first threshold according to the appearance frequency in the second text information. Next, the appearance frequency of each word belonging to the first word group in the third text information, which is related to past work of each of the plurality of search target users, is determined, and the candidate users are extracted according to the appearance frequency. Further, the manuals referred to in the past by each of the extracted candidate users are determined, and the priority of each candidate user is calculated such that the higher the appearance frequency of the word belonging to the first word group in the manuals, the higher the priority. In addition, for the candidate users thus extracted and the priority of which is calculated, the degree of recommendation is calculated on the basis of the appearance frequency of the words in the second word group (peripheral information PW), and the priority of each candidate user is calculated such that the higher the appearance frequency of the words belonging to the second word group in the manuals referred to in the past by each candidate user narrowed down on the basis of the degree of recommendation, the higher the priority. Information regarding the candidate users including priority is then presented to the first user, which is the counseled user. The candidate users can be presented to the counseled user together with the calculated priority or in an order according to the calculated priority. Further, the candidate users can also be notified of information regarding the counseled user, the trouble information TW, or the peripheral information PW.

### (3) Effects

As described above in detail, according to the second embodiment, similarly to the first embodiment, it is possible to search for a counselor having experience related to the trouble information TW and the peripheral information PW and having referred to related manuals a lot, and present the counselor to a person in charge.

Further, in the present embodiment, in a case where the document including the trouble information TW is not a case-specific document but manuals, the count number of “word groups included in the trouble information TW” in the document stored as the manuals reference count is, for example, tripled and stored. Thus, a person who “has a large sum of word group usage count histories” among the counselor candidates is ranked high as a person who has browsed the manuals a lot. That is, since it is not possible to contribute to the solution of the trouble at least without knowing the trouble information TW, the counselor candidates who can be the final counselor can be a person ranked high at this point of time.

Further, in addition, in the present embodiment, weighting (η, θ) in consideration of the importance of the “trouble information TW” and the “peripheral information PW” is also performed. Therefore, it is possible to change each importance by adjusting the weighting value. For example, in a case where the counselee cannot find a desired counselor candidate, the weighting value is adjusted by the administrator of the search server 1 or from the user terminal UTX of the counselee, and the possibility of finding a counselor candidate who can solve the trouble can be improved.

### Other Embodiments

Note that this invention is not limited to the embodiments described above.

For example, the description has been given assuming that the search server 1 includes the terminal handling content accumulation unit 15, the pairing condition holding unit 25, the manuals determination variable group space holding unit 35, and the pairing result holding unit 45, but this invention is not limited thereto. At least one of the terminal handling content accumulation unit 15, the pairing condition holding unit 25, the manuals determination variable group space holding unit 35, and the pairing result holding unit 45 may be provided in an external apparatus separate from the search server 1. The external apparatus may be a database server separate from the search server 1, a database provided in a cloud, or one of the user terminals UT. In addition, they may be provided in these dispersedly.

Similarly, the functional units F1 to F4, or the terminal handling content acquisition unit 11, the pairing condition generation unit 21, the pairing condition editing unit 22, the pairing processing execution unit 31, the pairing result presentation unit 41, and the pairing result notification unit 42 included in the search server 1 may be dispersedly arranged in a plurality of apparatuses, and these apparatuses may cooperate with each other to perform processing. In addition, these units may be implemented by use of a circuit. The circuit may be a dedicated circuit that implements a specific function, or may be a general-purpose circuit such as a processor.

In addition, the description has been given assuming that the search server 1 extracts candidates by determining work experience related to both the trouble information TW and the peripheral information PW for the workers as search targets. However, work experience related to only one of the trouble information TW and the peripheral information PW may be determined. Thus, the processing load of the search server 1 can be reduced, and the search processing speed can be increased. The counselee may be allowed to select at any time which of the trouble information TW and the peripheral information PW is used to make a search. In this case, it is possible to make a search according to the situation or preference of the counselee.

In addition, the description has been given assuming that the search server 1 determines the presence or absence of the work experience related to the trouble or calculates the degree of recommendation on the basis of the coverage degree or the handling degree as the possession amount of work experience. However, the possession amount of work experience may be simply the total number of appearances of vocabulary rather than the coverage degree or the handling degree. In this case, the search server 1 can select counselor candidates based on the total number of appearances of vocabulary included in the trouble information TW, narrow down the counselor candidates with a degree of recommendation based on the total number of appearances of vocabulary included in the peripheral information PW, and give priority according to the degree of manuals reference experience. Thus, the calculation amount can be reduced, and the processing speed can be increased.

In addition, the calculation of the degree of recommendation may be omitted. That is, the search server 1 may select the counselor candidates on the basis of the possession amount of work experience and the degree of manuals reference experience.

In addition, whether a document is manuals may be determined in advance by the terminal handling content acquisition unit 11 instead of the pairing processing execution unit 31. The terminal handling content acquisition unit 11 determines whether the document used by the user terminal UT is manuals by a method similar to the determination method in the pairing processing execution unit 31, and stores the determination result in the terminal handling content accumulation unit 15. For example, when the data held in the terminal handling content accumulation unit 15 is as illustrated in FIG. 9, the item “manuals” is added, and the determination result as to whether the document is manuals is stored therein. Alternatively, a list of documents determined as manuals may be accumulated together with paths of the documents in an accumulation unit different from the terminal handling content accumulation unit 15.

In addition, the pairing condition generation processing described with reference to FIG. 10 may consider the appearance frequency of each word in the first text information corresponding to the current work situation of the counselee. For example, in a case where a specific word frequently appears in the first text information, such processing may be performed that the possession amount (the coverage degree and the handling degree) of work experience related to the word strongly contributes to the degree of recommendation.

Further, the flow of each processing described above is not limited to the described procedure, and the order of some steps may be changed, or some steps may be performed simultaneously in parallel. In addition, the series of processing described above does not need to be executed continuously in terms of time, and each step may be executed at any timing.

The method described above can be stored in a recording medium (storage medium) such as a magnetic disk (floppy (registered trademark) disk, hard disk, or the like), an optical disk (CD-ROM, DVD, MO, or the like), or semiconductor memory (ROM, RAM, flash memory, or the like) as programs (software means) that can be executed by a computing machine (computer), and can also be distributed by being transmitted through a communication medium. Note that the programs stored on the medium side also include a setting program for configuring, in the computing machine, a software means (including not only an execution program but also tables and data structures) to be executed by the computing machine. The computing machine that implements the above apparatus executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or semiconductor memory provided in a computing machine or in a device connected via a network.

In addition, processing such as acquisition and division of text information can also be variously modified and implemented without departing from the gist of this invention.

Note that this invention is not limited to the above embodiments, and various modifications can be made in the implementation stage without departing from the gist of the invention. In addition, the embodiments may be implemented in appropriate combination, and in this case, combined effects can be obtained. Further, the above embodiments include various types of inventions, and various types of inventions can be extracted by a combination selected from a plurality of disclosed components. For example, even if some components are eliminated from all the components described in the embodiments, a configuration from which the components are eliminated can be extracted as an invention in a case where the problem can be solved and the effects can be obtained.

### REFERENCE SIGNS LIST

1 Search server
11 Terminal handling content acquisition unit
15 Terminal handling content accumulation unit
21 Pairing condition generation unit
22 Pairing condition editing unit
25 Pairing condition holding unit
31 Pairing processing execution unit
35 Manuals determination variable group space holding unit
41 Pairing result presentation unit
42 Pairing result notification unit
45 Pairing result holding unit
100 Search system

1. An information processing apparatus comprising:
information acquisition circuitry configured to acquire first text information handled in a terminal apparatus used by a first user in response to a search request issued by the first user to search for candidate users from among a plurality of users;
condition generation circuitry configured to divide words included in the first text information into a first word group having an appearance frequency lower than a first threshold and a second word group having an appearance frequency equal to or higher than the first threshold according to an appearance frequency in second text information related to past work of the first user;
search processing circuitry configured to
extract the candidate users from among the plurality of users according to an appearance frequency of a word belonging to the first word group in third text information related to past work of each user, and
determines manuals referred to in past by each of the extracted candidate users and calculates priority of each candidate user such that the higher the appearance frequency of the word belonging to the first word group in the manuals, the higher the priority; and
result output circuitry configured to output information for presenting information regarding the candidate users including the priority to the first user.

2. The information processing apparatus according to claim 1, wherein:
the search processing circuitry is further configured to:
further narrow down the candidate users from among the extracted candidate users according to an appearance frequency of a word belonging to the second word group in the third text information, and
calculate the priority for each candidate user such that the higher the appearance frequency of the words belonging to the first and second word groups in manuals referred to in past by each of the narrowed down candidate users, the higher the priority, and
the result output circuitry outputs the priority calculated for the candidate users together with information for identifying the candidate users as information regarding the candidate users.

3. The information processing apparatus according to claim 1, wherein:
the search processing circuitry is further configured to:
narrow down the candidate users from among the extracted candidate users according to an appearance frequency of a word belonging to the second word group in the third text information,
calculate the priority of each candidate user such that the higher the appearance frequency of the word belonging to the second word group in manuals referred to in past by each of the narrowed down candidate users, the higher the priority, and
calculate a final priority based on the priority based on the appearance frequency of the word belonging to the first word group and the priority based on the appearance frequency of the word belonging to the second word group, and
the result output circuitry outputs the final priority calculated for the candidate users together with information for identifying the candidate users as the information regarding the candidate users.

4. The information processing apparatus according to claim 3, wherein:
the search processing circuitry weights each of the priority based on the appearance frequency of the word belonging to the first word group and the priority based on the appearance frequency of the word belonging to the second word group and calculates the final priority.

5. The information processing apparatus according to claim 1, wherein the search processing circuitry is further configured to:
determine manuals referred to in past by each of the candidate users by comparing a determination variable of a document calculated based on a matching rate of a document with a manual format, range of users of a file of the document, and a number of times of use, period, and periodicity of the file of the document, with a determination variable group space of the manuals calculated based on distribution of a determination variable calculated in advance from a plurality of manuals.

6. The information processing apparatus according to claim 1, wherein the result output circuitry further outputs information for presenting information regarding the first user and information regarding the first word group to each of the candidate users.

7. An information processing method, comprising:
acquiring first text information handled in a terminal used by a first user in response to a search request issued by the first user to search for candidate users from among a plurality of users;
dividing words included in the first text information into a first word group having an appearance frequency lower than a first threshold and a second word group having an appearance frequency equal to or higher than the first threshold according to an appearance frequency in second text information related to past work of the first user;
extracting the candidate users from among the plurality of users according to an appearance frequency of a word belonging to the first word group in third text information related to past work of each user;
determining manuals referred to in past by each of the extracted candidate users and calculating priority of each candidate user such that the higher the appearance frequency of the word belonging to the first word group in the manuals, the higher the priority; and
outputting information for presenting information regarding the candidate users including the priority to the first user.

8. A non-transitory computer readable medium storing a program for causing a computer to execute the method of claim 7.
